(19) United States
(12) Patent Application Publication
(10) Pub. No.: US 2013/0042673 A1
(43) Pub. Date: Feb. 21, 2013

(54) Methods and Apparatus for Analyzing Samples and Collecting Sample Fractions

(71) Applicants: Raaidah Saari-Nordhaus, Antioch, IL (US); Romulus Gaita, Des Plaines, IL (US); Scott Anderson, Lindenhurst, IL (US); Washington Mendoza, Lake in the Hills, IL (US); James Anderson, JR., Arlington Heights, IL (US)

(72) Inventors: Raaidah Saari-Nordhaus, Antioch, IL (US); Romulus Gaita, Des Plaines, IL (US); Scott Anderson, Lindenhurst, IL (US); Washington Mendoza, Lake in the Hills, IL (US); James Anderson, JR., Arlington Heights, IL (US)

(21) Appl. No.: 13/266,870

(22) PCT Filed: May 5, 2011
(86) PCT No.: PCT/US11/35366

§ 371 Date: Apr. 4, 2012

Related U.S. Application Data
(60) Provisional application No. 61/332,478, filed on May 7, 2010.

(51) Int. Cl. G01N 30/80

(52) U.S. Cl. 73/61.55

(57) ABSTRACT

Methods and apparatus for analyzing a sample using at least one detector are disclosed.

### FIELD OF THE INVENTION

The present invention is directed to methods and apparatus for analyzing samples and collecting sample fractions with a chromatography system.

### BACKGROUND OF THE INVENTION

There is a need in the art for methods of efficiently and effectively analyzing samples and collecting sample fractions with a chromatography system. There is also a need in the art for an apparatus capable of effectively analyzing samples and collecting sample fractions.

### SUMMARY OF THE INVENTION

The present invention relates to the discovery of methods for analyzing samples and collecting sample fractions with a chromatography system. The disclosed methods provide a number of advantages over known methods of analyzing samples. For example, the disclosed methods of the present invention may utilize a splitter or a shuttle valve to actively control fluid flow through at least one detector so that process variables (e.g., flow restrictions, total flow rate, temperature, and/or solvent composition) do not negatively impact the fluid flow through the at least one detector. The disclosed methods of the present invention may also utilize one or more detectors to provide a more complete analysis of a given sample, as well as collection of one or more sample fractions in response to one or more detector signals from the one or more detectors.

The present invention is directed to methods of analyzing samples and collecting sample fractions. In one exemplary embodiment, the method of analyzing a sample comprises the steps of generating a signal from one or more detectors in a liquid chromatography system, the signal comprising a detection response component from at least one detector; and collecting a new sample fraction in a fraction collector in response to a change in the signal, wherein the amplitude of the signal is modified by the liquid chromatography system. In one exemplary embodiment, the signal may comprise (i) a detection response component from at least one optical absorbance detector (e.g., an UV detector) and (ii) a detection response component from at least one evaporative particle detector. In one exemplary embodiment, chromophoric or non-chromophoric solvents may be utilized in the chromatography system as the carrier fluid. In another exemplary embodiment, the composite signal may comprise (i) a detection response component comprising two or more detector responses from an optical absorbance detector (e.g., an UV detector) at two or more specific optical wavelengths and (ii) a detection response component from an evaporative particle detector.

In another exemplary embodiment, the method of analyzing a sample comprises the steps of generating a signal from one or more detectors in a liquid chromatography system, the signal comprising a detection response component from each detector; and collecting a new sample fraction in a fraction collector in response to a change in the signal, wherein amplitude of the signal is modified by electronic or digital means. In one exemplary embodiment, the gain of the signal is modified by a component of the chromatography system, such as by computer software or a computer readable medium.

In a further exemplary embodiment, the method of analyzing a sample comprises the steps of generating a signal from one or more detectors in a liquid chromatography system, the signal comprising a detection response component from each detector; and collecting a new sample fraction in a fraction collector in response to a change in the signal, wherein amplitude of the signal is modified by optical means. In one exemplary embodiment, amplitude of the signal is modified by a light source in the one or more of the detectors of the chromatography system, such as by changing light intensity of a detector, using an interchangeable light source, or using multiple light sources in the detector(s).

In an even further exemplary embodiment, the method of analyzing a sample comprises the steps of generating a signal from one or more detectors in a liquid chromatography system, the signal comprising a detection response component from each detector; and collecting a new sample fraction in a fraction collector in response to a change in the signal, wherein amplitude of the signal is modified by fluidic means. In one exemplary embodiment, amplitude of the signal is modified by changing the amount of sample transferred to the one or more of the detectors of the chromatography system, such as by changing the design of the sample transfer device. For example, in an exemplary embodiment where a shuttle valve is utilized to transfer the sample to the one or more detectors, the amount of sample transferred may be accomplished by changing the size or shape of the shuttle valve rotor or stator chambers or channels, the use of multiple valves or multiple valve components having different stator or rotor chamber or channel sizes, or by using different valve operating conditions (e.g., changing valve rotation frequency). In an exemplary embodiment where other types of splitter systems are utilized to transfer the sample to the one or more detectors, the sample transfer rate may be modified by simple component interchange, by using multiple splitters, or by modifying the operating conditions of the splitter(s).

In yet a further exemplary embodiment, the method of analyzing a sample comprises the steps of generating a signal from one or more detectors in a liquid chromatography system, the signal comprising a detection response component from each detector; and collecting a new sample fraction in a fraction collector in response to a change in the signal, wherein amplitude of the signal is modified by the detector design. In one exemplary embodiment, amplitude of the signal is modified by changing the physical properties of sample that reaches the one or more of the detectors of the chromatography system. For example, in one exemplary embodiment where an EPD is utilized, the physical properties of sample that reaches optics portion(s) of the detector may be changed, such as by the use of different impactors (e.g., flat plates or screens) or use of different drift tubes, or combinations thereof. In another exemplary embodiment, the signal level of the one or more detector(s) may be modified by changing the mechanical elements of the detector(s). For example, in an exemplary embodiment where an EPD is utilized, the nebulizer, drift tube, or optics block design, or combinations thereof may be modified. In another exemplary embodiment, the signal level of the one or more detector(s) may be modified by changing the operating conditions of the detector(s).

In another exemplary embodiment, the method of analyzing a sample comprises the steps of generating a signal from one or more detectors in a liquid chromatography system, the signal comprising a detection response component from at least one detector; and collecting a new sample fraction in a fraction collector in response to a change in the signal; wherein amplitude of the signal is at least about 2 mV.

In a further exemplary embodiment, the method of analyzing a sample comprises the steps of generating a signal from one or more detectors in a liquid chromatography system, the signal comprising a detection response component from at least one detector; and collecting a new sample fraction in a fraction collector in response to a change in the signal; wherein the sample fraction is less than or equal to about 100 mg.

In an even further exemplary embodiment, the method of analyzing a sample comprises the steps of generating a signal from one or more detectors in a liquid chromatography system, the signal comprising a detection response component from at least one detector; and collecting a new sample fraction in a fraction collector in response to a change in the signal; wherein the signal is generated by at least about 40 uL/min of sample provided to the one or more detectors.

In another exemplary embodiment, the method of analyzing a sample comprises the steps of generating a signal from one or more detectors in a liquid chromatography system, the signal comprising a detection response component from at least one detector; and collecting a new sample fraction in a fraction collector in response to a change in the signal; wherein the one or more detectors comprises an ELSD and the signal is generated from a light source of greater than about 1 mW.

In a further exemplary embodiment, the method of analyzing a sample comprises the steps of generating a signal from two or more detectors in a liquid chromatography system, the signal comprising a detection response component from at least one detector; and collecting a new sample fraction in a fraction collector in response to a change in the signal; wherein the two or more detectors comprises multiple detectors having different dynamic ranges.

The present invention is also directed to an apparatus capable of analyzing a sample. In one exemplary embodiment, the apparatus for analyzing a sample comprises system hardware operatively adapted to generate a signal from one or more detectors in a liquid chromatography system, the signal comprising a detection response component from at least one detector; and a fraction collector operatively adapted to collect a new sample fraction in response to a change in the signal, wherein the liquid chromatography system is operatively adapted to modify amplitude of the signal.

In another exemplary embodiment, the apparatus for analyzing a sample comprises system hardware operatively adapted to generate a signal from one or more detectors in a liquid chromatography system, the signal comprising a detection response component from at least one detector; and a fraction collector operatively adapted to collect a new sample fraction in response to a change in the signal, wherein the liquid chromatography system is operatively adapted to modify amplitude of the signal by electronic or digital means. In one exemplary embodiment, the gain of the signal is modified by a component of the chromatography system, such as by computer software or a computer readable medium.

In another exemplary embodiment, the apparatus for analyzing a sample comprises system hardware operatively adapted to generate a signal from one or more detectors in a liquid chromatography system, the signal comprising a detection response component from at least one detector; and a fraction collector operatively adapted to collect a new sample fraction in response to a change in the signal, wherein the liquid chromatography system is operatively adapted to modify amplitude of the signal by optical means. In one exemplary embodiment, amplitude of the signal is modified by a light source in the one or more of the detectors of the chromatography system, such as by changing light intensity of a detector, using an interchangeable light source, or using multiple light sources in the detector.

In another exemplary embodiment, the apparatus for analyzing a sample comprises system hardware operatively adapted to generate a signal from one or more detectors in a liquid chromatography system, the signal comprising a detection response component from at least one detector; and a fraction collector operatively adapted to collect a new sample fraction in response to a change in the signal, wherein the liquid chromatography system is operatively adapted to modify amplitude of the signal by fluidic means. In one exemplary embodiment, amplitude of the signal is modified by changing the amount of sample transferred to the one or more of the detectors of the chromatography system, such as by changing the design of the sample transfer device. For example, in an exemplary embodiment where a shuttle valve is utilized to transfer the sample to the one or more detectors, the amount of sample transferred may be accomplished by changing the size or shape of the shuttle valve rotor or stator chambers or channels, the use of multiple valves or multiple valve components having different stator or rotor chamber or channel sizes, or by using different valve operating conditions (e.g., changing valve rotation frequency). In an exemplary embodiment where other types of splitter systems are utilized to transfer the sample to the one or more detectors, the sample transfer rate may be modified by simple component interchange, by using multiple splitters, or by modifying the operating conditions of the splitter(s).

In another exemplary embodiment, the apparatus for analyzing a sample comprises system hardware operatively adapted to generate a signal from one or more detectors in a liquid chromatography system, the signal comprising a detection response component from at least one detector; and a fraction collector operatively adapted to collect a new sample fraction in response to a change in the signal, wherein the liquid chromatography system is operatively adapted to modify amplitude of the signal by the detector design. In one exemplary embodiment, amplitude of the signal is modified by changing the physical properties of sample that reaches the one or more of the detectors of the chromatography system. For example, in one exemplary embodiment where an EPD is utilized, the physical properties of sample that reaches optics portion(s) of the one or more detectors may be changed, such as by the use of different impactors (e.g., flat plates or screens) or use of different drift tubes, or combinations thereof. In another exemplary embodiment, the signal level of the one or more detector(s) may be modified by changing the mechanical elements of the detector(s). For example, in an exemplary embodiment where an EPD is utilized, the nebulizer, drift tube, or optics block design, or combinations thereof may be modified. In another exemplary embodiment, the signal level of the one or more detector(s) may be modified by changing the operating conditions of the detector(s).

In an exemplary embodiment, the apparatus for analyzing a sample comprises system hardware operatively adapted to generate a signal from one or more detectors in a liquid chromatography system, the signal comprising a detection response component from one or more detectors; and a fraction collector operatively adapted to collect a new sample fraction in response to a change in the signal; wherein the liquid chromatography system is operatively adapted to generate an amplitude of the signal of at least about 2 mV.

In a further exemplary embodiment, the apparatus for analyzing a sample comprises system hardware operatively adapted to generate a signal from one or more detectors in a liquid chromatography system, the signal comprising a detection response component from one or more detectors; and a fraction collector operatively adapted to collect a new sample fraction in response to a change in the signal; wherein the liquid chromatography system is operatively adapted to collect the sample fraction of less than or equal to about 100 mg.

In another exemplary embodiment, the apparatus for analyzing a sample comprises system hardware operatively adapted to generate a signal from one or more detectors in a liquid chromatography system, the signal comprising a detection response component from one or more detectors; and a fraction collector operatively adapted to collect a new sample fraction in response to a change in the signal; wherein the liquid chromatography system is operatively adapted to generate the signal from at least about 30 uL/min. of sample provided to the one or more detectors.

In a further exemplary embodiment, the apparatus for analyzing a sample comprises system hardware operatively adapted to generate a signal from one or more detectors in a liquid chromatography system, the signal comprising a detection response component from one or more detectors; and a fraction collector operatively adapted to collect a new sample fraction in response to a change in the signal; wherein the one or more detectors comprises an ELSD and the signal is generated from a light source of greater than about 1 mW.

In another exemplary embodiment, the apparatus for analyzing a sample comprises system hardware operatively adapted to generate a signal from two or more detectors in a liquid chromatography system, the signal comprising a detection response component from one or more detectors; and a fraction collector operatively adapted to collect a new sample fraction in response to a change in the signal; wherein the two or more detectors comprises multiple detectors having different dynamic ranges.

In yet another exemplary embodiment, the apparatus for analyzing a sample comprises a fraction collector in a liquid chromatography system, the fraction collector being operatively adapted to (i) recognize, receive and process one or more signals from at least one detector, and (ii) collect one or more sample fractions based on the one or more signals.

The methods and apparatus of the present invention may comprise at least one detector. Suitable detectors include, but are not limited to, non-destructive detectors (i.e., detectors that do not consume or destroy the sample during detection) such as UV, RI, conductivity, fluorescence, light scattering, viscometry, polorimetry, and the like; and/or destructive detectors (i.e., detectors that consume or destroy the sample during detection) such as evaporative particle detectors (EPD), e.g., evaporative light scattering detectors (ELSD), condensation nucleation light scattering detectors (CNLSD), etc., corona discharge, mass spectrometry, atomic adsorption, and the like. For example, the apparatus of the present invention may include at least one UV detector, at least one evaporative light scattering detector (ELSD), at least one mass spectrometer (MS), at least one condensation nucleation light scattering detector (CNLSD), at least one corona discharge detector, at least one refractive index detector (RID), at least one fluorescence detector (FD), chiral detector (CD), at least one electrochemical detector (ED) (e.g., amperometric or coulometric detectors), or any combination thereof. In one exemplary embodiment, the detector may comprise one or more evaporative particle detector(s) (EPD), which allows the use of chromaphoric and non-chromaphoric solvents as the mobile phase. In a further exemplary embodiment, a non-destructive detector may be combined with a destructive detector, which enables detection of various compound specific properties, molecular weight, chemical structure, elemental composition and chirality of the sample, such as, for example, the chemical entity associated with the peak.

The present invention is even further directed to computer readable medium having stored thereon computer-executable instructions for performing one or more of the method steps in any of the exemplary methods described herein. The computer readable medium may be used to load application code onto an apparatus or an apparatus component, such as any of the apparatus components described herein, in order to (i) provide interface with an operator and/or (ii) provide logic for performing one or more of the method steps described herein.

These and other features and advantages of the present invention will become apparent after a review of the following detailed description of the disclosed exemplary embodiments and the appended claims.

### BRIEF DESCRIPTION OF THE FIGURES

FIG. 1 depicts an exemplary liquid chromatography system of the present invention comprising a splitter pump to actively control fluid flow to a detector;

FIG. 2 depicts another exemplary liquid chromatography system of the present invention comprising a splitter pump and a detector;

FIG. 3A depicts an exemplary liquid chromatography system of the present invention comprising a shuttle valve and a detector;

FIGS. 3B-3C depict the operation of an exemplary shuttle valve suitable for use in the present invention;

FIG. 4 depicts an exemplary liquid chromatography system of the present invention comprising a splitter pump and two detectors;

FIG. 5 depicts an exemplary liquid chromatography system of the present invention comprising two splitter pumps and two detectors;

FIG. 6 depicts an exemplary liquid chromatography system of the present invention comprising a shuttle valve and two detectors;

FIG. 7 depicts an exemplary liquid chromatography system of the present invention comprising two shuttle valves and two detectors;

FIG. 8 depicts an exemplary liquid chromatography system of the present invention comprising a splitter pump, an evaporative light scattering detector (ELSD), and an ultraviolet (UV) detector;

FIG. 9 depicts another exemplary liquid chromatography system of the present invention comprising a splitter pump, an ELSD and an UV detector;

FIGS. 10A-10C depict the operation of an exemplary shuttle valve suitable for use in the present invention;

FIG. 11 depicts a graph of ELSD response values for the separation of various natural products using an exemplary chromatography system of the present invention; and

FIG. 12 depicts a graph of ELSD detector response values for the separation of caffeine using an exemplary chromatography system of the present invention.

### DETAILED DESCRIPTION OF THE INVENTION

To promote an understanding of the principles of the present invention, descriptions of specific exemplary embodiments of the invention follow and specific language is used to describe the specific exemplary embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

It must be noted that as used herein and in the appended claims, the singular forms “a”, “and”, and “the” include plural referents unless the context clearly dictates otherwise. Thus, for example, reference to “a solvent” includes a plurality of such solvents and reference to “solvent” includes reference to one or more solvents and equivalents thereof known to those skilled in the art, and so forth.

“About” modifying, for example, the quantity of an ingredient in a composition, concentrations, volumes, process temperatures, process times, recoveries or yields, flow rates, and like values, and ranges thereof, employed in describing the exemplary embodiments of the disclosure, refers to variation in the numerical quantity that may occur, for example, through typical measuring and handling procedures; through inadvertent error in these procedures; through differences in the ingredients used to carry out the methods; and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities.

As used herein, the term “amplitude” means the size of chromatographic peak displayed by a detector.

As used herein, the term “chromatography” means a physical method of separation in which the components to be separated are distributed between two phases, one of which is stationary (stationary phase) while the other (the mobile phase) moves in a definite direction.

As used herein, the term “dynamic range” means the ratio of a specified maximum level of a parameter, such as power, current, voltage or frequency, to the minimum detectable value of that parameter. In the present application dynamic range means the multiple between the smallest and largest sample amount at which the detector will properly trigger the fraction collector.

As used herein, the term “gain” means the amplification of the detector signal.

As used herein, the term “liquid chromatography” means the separation of mixtures by passing a fluid mixture dissolved in a “mobile phase” through a column comprising a stationary phase, which separates the analyte (i.e., the target substance) from other molecules in the mixture and allows it to be isolated.

As used herein, the term “mobile phase” means a fluid liquid, a gas, or a supercritical fluid that comprises the sample being separated and/or analyzed and the solvent that moves the sample comprising the analyte through the column. The mobile phase moves through the chromatography column or cartridge (i.e., the container housing the stationary phase) where the analyte in the sample interacts with the stationary phase and is separated from the sample.

As used herein, the term “stationary phase” means material fixed in the column or cartridge that selectively adsorbs the analyte from the sample in the mobile phase separation of mixtures by passing a fluid mixture dissolved in a “mobile phase” through a column comprising a stationary phase, which separates the analyte to be measured from other molecules in the mixture and allows it to be isolated.

As used herein, the term “flash chromatography” means the separation of mixtures by passing a fluid mixture dissolved in a “mobile phase” under pressure through a column comprising a stationary phase, which separates the analyte (i.e., the target substance) from other molecules in the mixture and allows it to be isolated.

As used herein, the term “shuttle valve” means a control valve that regulates the supply of fluid from one or more source(s) to another location. The shuttle valve may utilize rotary or linear motion to move a sample from on fluid to another.

As used herein, the term “fluid” means a gas, liquid, and supercritical fluid.

As used herein, the term “laminar flow” means smooth, orderly movement of a fluid, in which there is no turbulence, and any given subcurrent moves more or less in parallel with any other nearby subcurrent.

As used herein, the term “substantially” means within a reasonable amount, but includes amounts which vary from about 0% to about 50% of the absolute value, from about 0% to about 40%, from about 0% to about 30%, from about 0% to about 20% or from about 0% to about 10%.

The present invention is directed to methods of analyzing samples and collecting sample fractions. The present invention is further directed to apparatus capable of analyzing samples and collecting sample fractions. The present invention is even further directed to computer software suitable for use in an apparatus or apparatus component that is capable of analyzing samples and collecting sample fractions, wherein the computer software enables the apparatus to perform one or more method steps as described herein.

In the chromatography industry, various types of samples are candidates for isolation and purification by flash chromatography. In an exemplary embodiment according to the present invention, detector signals from the sample components trigger a fraction collector that isolates the compounds of interest from the rest of the matrix. For proper operation, the amplitude of a component's detector signal must be sufficiently large for the software to discriminate between the component's signal and the background. In operation, the user inputs a threshold amplitude value. Whenever the detector signal amplitude exceeds the threshold, the fraction collector directs the peak to a collection vessel. If the component signal amplitude is too low (below the threshold) it won't be collected. In many cases, the components have sufficient quantity to generate signal amplitudes that will trigger the fraction collector. However, for some sample types, such as in lead generation or natural product isolation, the components are present in insufficient quantity to trigger the fraction collectors. In those cases it's necessary to increase the detector signal amplitude so that collection is possible.

A description of exemplary methods of analyzing samples and apparatus capable of analyzing samples is provided below.

### I. Methods of Analyzing Samples

The present invention is directed to methods of analyzing samples and collecting sample fractions. The methods of analyzing a sample may contain a number of process steps, some of which are described below.

A. Active Control of Fluid Flow to a Detector

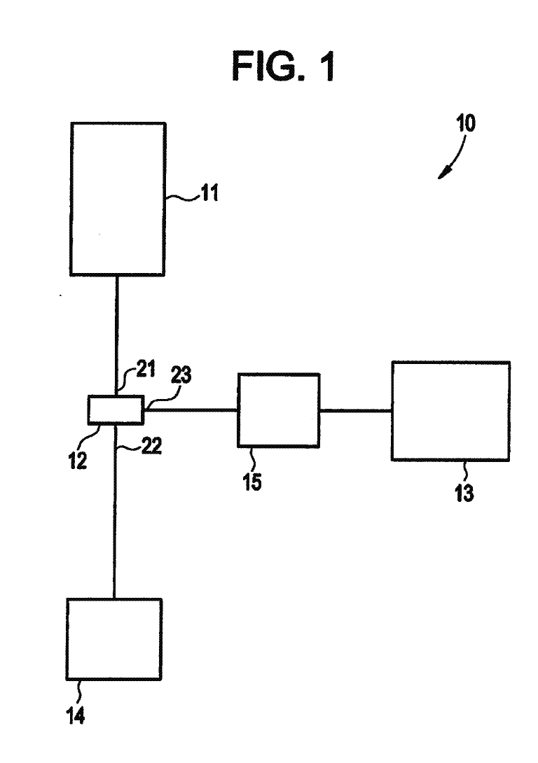

In some exemplary embodiments of the present invention, the method of analyzing a sample comprises a step comprising actively controlling fluid flow to a detector via a splitter pump or a shuttle valve. One exemplary liquid chromatography system depicting such a method step is shown in FIG. 1. As shown in FIG. 1, exemplary liquid chromatography system 10 comprises (i) a chromatography column 11, (ii) a tee 12 having a first inlet 21, a first outlet 22 and a second outlet 23, (iii) a fraction collector 14 in fluid communication with first outlet 22 of tee 12, (iv) a first detector 13 in fluid communication with second outlet 23 of tee 12, and (v) a splitter pump 15 positioned in fluid communication with second outlet 23 of tee 12 and first detector 13.

In this exemplary system, splitter pump 15 actively controls fluid flow to first detector 13. As used herein, the phrase “actively controls” refers to the ability of a given splitter pump or shuttle valve to control fluid flow through a given detector even though there may be changes in fluid flow rate in other portions of the liquid chromatography system. Unlike “passive” flow splitters that merely split fluid flow, the splitter pumps and shuttle valves used in the present invention control fluid flow to at least one detector regardless of possible fluctuations in fluid flow within the liquid chromatography system such as, for example, flow restrictions, total flow rate, temperature, and/or solvent composition.

The step of actively controlling fluid flow to a given detector may comprise, for example, sending an activation signal to the splitter pump or shuttle valve to (i) activate the splitter pump or shuttle valve, (ii) deactivate the splitter pump or shuttle valve, (iii) change one or more flow and/or pressure settings of the splitter pump or shuttle valve, or (iv) any combination of (i) to (iii). Suitable flow and pressure settings include, but are not limited to, (i) a valve position, (ii) splitter pump or shuttle valve pressure, (iii) air pressure to a valve, or (iv) any combinations of (i) to (iii). Typically, the activation signal is in the form of, for example, an electrical signal, a pneumatic signal, a digital signal, or a wireless signal.

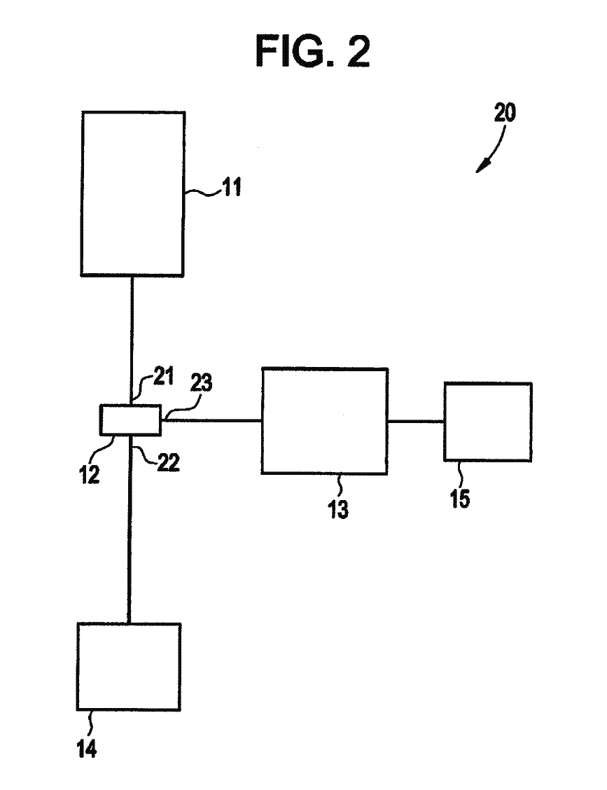

As shown in FIG. 1, in exemplary liquid chromatography system 10, the step of actively controlling fluid flow to detector 13 comprises using splitter pump 15 to pump fluid from tee 12 into detector 13. In other exemplary embodiments, the step of actively controlling fluid flow to a detector may comprise using a splitter pump to pull fluid through a detector. Such a system configuration is shown in FIG. 2.

FIG. 2 depicts exemplary liquid chromatography system 20 comprises chromatography column 11; tee 12 having first inlet 21, first outlet 22 and second outlet 23; fraction collector 14 in fluid communication with first outlet 22 of tee 12; first detector 13 in fluid communication with second outlet 23 of tee 12; and splitter pump 15 positioned so as to pull fluid through detector 13 from second outlet 23 of tee 12.

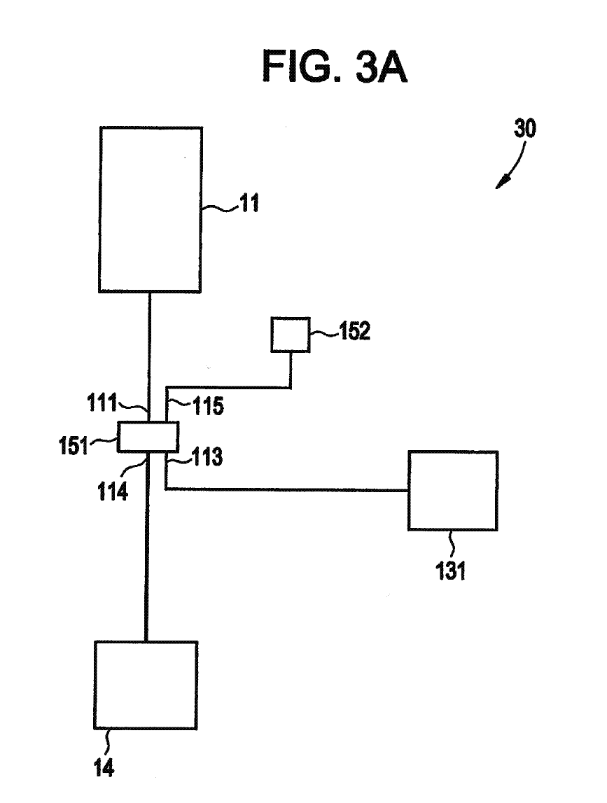

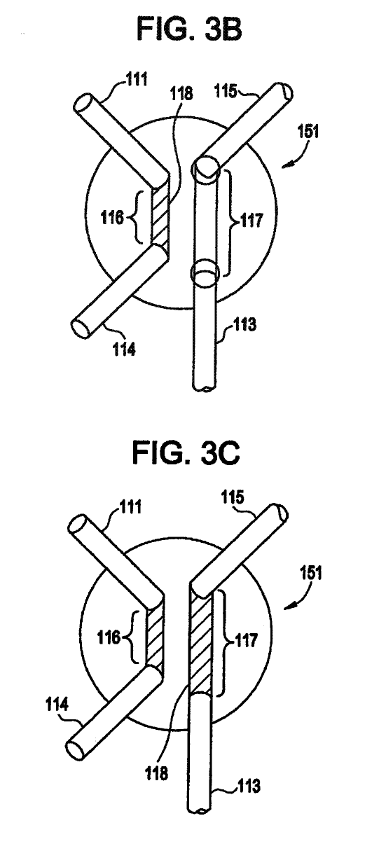

In some desired exemplary embodiments, a shuttle valve, such as exemplary shuttle valve 151 shown in FIGS. 3A-3C is used to actively control fluid flow to a detector such as detector 131. As shown in FIG. 3A, exemplary liquid chromatography system 30 comprises chromatography column 11; shuttle valve 151 having chromatography cartridge inlet 111, fraction collector outlet 114, gas or liquid inlet 115 and detector outlet 113; fraction collector 14 in fluid communication with fraction collector outlet 114 of shuttle valve 151; first detector 131 in fluid communication with detector outlet 113 of shuttle valve 151; and fluid supply 152 providing fluid to gas or liquid inlet 115 of shuttle valve 151.

In an even further exemplary embodiment of the present invention, a method of analyzing a sample of fluid using chromatography includes the steps of providing a first fluid of effluent from a chromatography column; providing a second fluid to carry the sample of fluid to at least one detector; using a shuttle valve to remove an aliquot sample of fluid from the first fluid and transfer the aliquot to the second fluid while maintaining a continuous path of the second fluid through the shuttle valve; using at least one detector to observe the aliquot sample of fluid; and collecting a new sample fraction of the first fluid in a fraction collector in response to a change in a detector response. In one exemplary embodiment, a continuous flow path of the first fluid through the shuttle valve is maintained when the aliquot sample of fluid is removed from the first fluid. In another exemplary embodiment, continuous flow paths of both the first fluid and the second fluid through the shuttle valve are maintained when the aliquot sample of fluid is removed from the first fluid and transferred to the second fluid.

In another exemplary embodiment according to the present invention, a method of analyzing a sample of fluid using chromatography includes the steps of providing a first fluid comprising the sample; using a shuttle valve to remove an aliquot sample of fluid from the first fluid without substantially affecting flow properties of the first fluid through the shuttle valve; using at least one detector to observe the aliquot sample of fluid; and collecting a new sample fraction of the first stream in a fraction collector in response to a change in at least one detector response. The flow of the first fluid through the shuttle valve may be substantially laminar, due to the first fluid path or channel being substantially linear or straight through at least a portion of the valve. In a further exemplary embodiment, the pressure of the first fluid through the shuttle valve remains substantially constant and/or it does not substantially increase. In another exemplary embodiment, the flow rate of the first fluid may be substantially constant through the shuttle valve. In an alternative exemplary embodiment, a second fluid is utilized to carry the aliquot sample of fluid from the shuttle valve to the detector(s). The flow of the second fluid through the shuttle valve may be substantially laminar due to the second fluid path or channel being substantially linear or straight through at least a portion of the valve. In an exemplary embodiment, the pressure of the second fluid through the shuttle valve is substantially constant and/or it does not substantially increase. In another exemplary embodiment, the flow rate of the second fluid may be substantially constant through the shuttle valve.

FIGS. 3B-3C depict how a shuttle valve in one exemplary embodiment operates within a given liquid chromatography system. As shown in FIG. 3B, shuttle valve 151 comprises chromatography cartridge inlet 111, which provides fluid flow from a chromatography column (e.g., column 11) to shuttle valve 151; an incoming sample aliquot volume 116; fraction collector outlet 114, which provides fluid flow from shuttle valve 151 to a fraction collection (e.g., fraction collection 14); gas or liquid inlet 115, which provides gas (e.g., air, nitrogen, etc.) or liquid (e.g., an alcohol) flow through a portion of shuttle valve 151; outgoing sample aliquot volume 117; and detector outlet 113, which provides fluid flow from shuttle valve 151 to a detector (e.g., detector 131, such as a ELSD).

As fluid flows through shuttle valve 151 from chromatography cartridge to inlet 111 to fraction collector outlet 114, incoming sample aliquot volume 116 is filled with a specific volume of fluid referred to herein as sample aliquot 118 (shown as the shaded area in FIG. 3B). At a desired time, shuttle valve 151 transfers sample aliquot 118 within incoming sample aliquot volume 116 into outgoing sample aliquot volume 117 as shown in FIG. 3C. Once sample aliquot 118 is transferred into outgoing sample aliquot volume 117, gas or liquid flowing from inlet 115 through outgoing sample aliquot volume 117 transports sample aliquot 118 to detector 131 (e.g., an ELSD) via detector outlet 113.

Shuttle valve 151 may be programmed to remove a sample aliquot (e.g., sample aliquot 118) from a sample for transport to at least one detector at a desired sampling frequency. In one exemplary embodiment, the sampling frequency is at least 1 sample aliquot every 10 seconds (or at least 1 sample aliquot every 5 seconds, or at least 1 sample aliquot every 3 seconds, or at least 1 sample aliquot every 2 seconds, or 1 sample aliquot every 0.5 seconds, or at least 1 sample aliquot every 0.1 seconds).

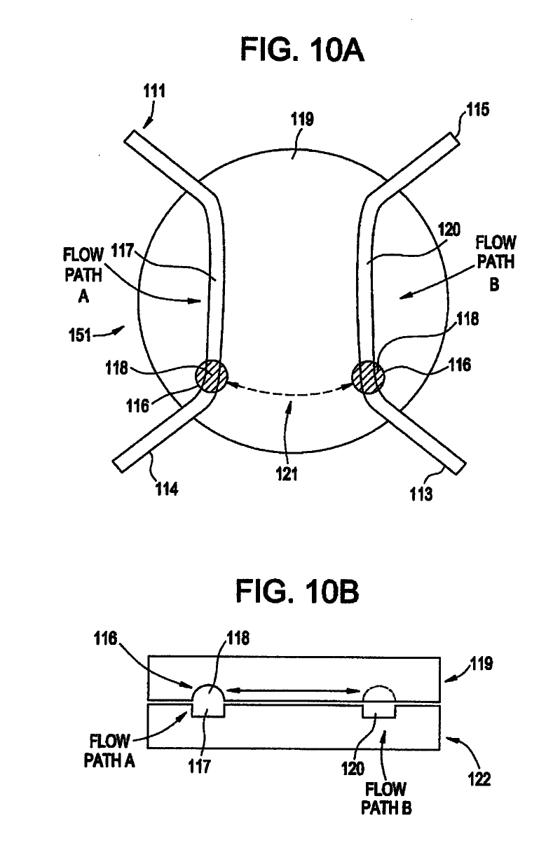

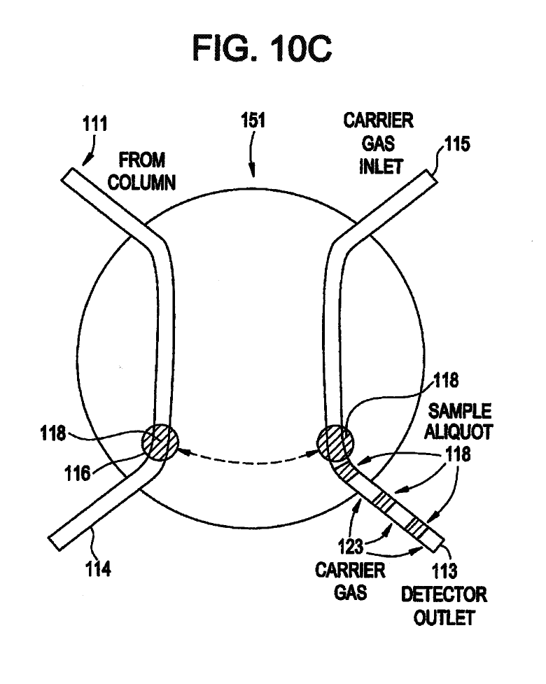

FIGS. 10A-C depict an exemplary shuttle valve of the present invention and how it operates within a given liquid chromatography system. As shown in FIG. 10A, shuttle valve 151 comprises chromatography cartridge inlet 111, which provides fluid flow from a chromatography column (e.g., column 11) to shuttle valve 151; channel 117 connecting inlet 111 to outlet 114; an incoming sample aliquot volume 118 in dimple 116 of dynamic body 119; fraction collector outlet 114, which provides fluid flow from shuttle valve 151 to a fraction collection (e.g., fraction collection 14); gas or liquid inlet 115, which provides gas (e.g., air, nitrogen, etc.) or liquid (e.g., an alcohol) flow through shuttle valve 151; outgoing sample aliquot volume 118 in dimple 116; channel 120 connecting inlet 115 to outlet 113; and detector outlet 113, which provides fluid flow from shuttle valve 151 to a detector (e.g., detector 131, such as a ELSD).

As fluid flows through shuttle valve 151 from chromatography cartridge to inlet 111 to fraction collector outlet 114 via channel 117, incoming sample aliquot volume 118 in dimple 116 is filled with a specific volume of fluid referred to herein as sample aliquot 118 (shown as the shaded area in FIG. 10A). At a desired time, shuttle valve 151 transfers sample aliquot 118 within dimple 116 taken from channel 117 to channel 120 by rotating the dimple 116 in dynamic body 119 via dimple rotation path 121. Once sample aliquot 118 is transferred into channel 120, gas or liquid flowing from inlet 115 through channel 120 transports sample aliquot 118 to detector 131 (e.g., an ELSD) via detector outlet 113. Another advantage of the shuttle valve of the present invention relates to the fluidics design of the channels through the valve. In order to minimize backpressure in the chromatography system, the flow through channels 117 and 120 is continuous. This is accomplished by locating channels 117 and 120 in static body 122 such that no matter what position the dynamic body 119 is in, the flow through shuttle valve 151 is continuous (as shown in FIG. 10B). As shown in FIG. 10A, at least a portion of the sample stream channel 117 and detector stream channel 120 may be substantially planar or circumferential, which reduces turbulence and further minimizes pressure increase through the valve. In addition, at least a portion of the sample stream channel 117 and detector stream channel 120 may be substantially parallel to dimple 116 when contiguous with it, which further limits turbulent flow and any increase in pressure in the valve. This includes those configurations that do not increase pressure within the valve of more than 50 psi, preferably not more than 30 psi, more preferably not more than 20 psi, and even more preferably not more than 10, 9, 8, 7, 6, 5, 4, 3, 2, or 1 psi. Dimple 116 is located in the dynamic body 119 and is in fluid communication with the face of the dynamic body that is contiguous with the static body 122, whereby when the dynamic body 119 is in a first position, the dimple 116 will be in fluid communication with the sample stream channel 117, and when moved to a second position, the dimple 116 will be in fluid communication with the detector stream channel 120. The dimple 116 may be of any shape but is depicted as a concave semi sphere, and it may be or any size. In an exemplary embodiment, the dimple may be extremely small in size (e.g., less than 2000 mL, preferably less than about 500 mL, more preferably less than about 100 mL, and even more preferably less than about 1 mL, but may include any size from 1 mL to 2000 mL), which allows for rapid sampling. In addition, small dimple 116 size allows for a very short dimple rotation path 121, which significantly reduces wear on the surfaces of the dynamic body 119 and the static body 122 and results in a shuttle valve 151 having extended service life before maintenance is required (e.g., more than 10 million cycles are possible before service). Even though a rotary motion shuttle valve is depicted in FIG. 10A-C, linear motion shuttle valves, or their equivalent, may be employed in the present invention.

Shuttle valve 151 may be programmed to remove a sample aliquot (e.g., sample aliquot 118) from a sample for transport to at least one detector at a desired sampling frequency. In one exemplary embodiment, the sampling frequency is at least 1 sample aliquot every 10 seconds (or at least 1 sample aliquot every 5 seconds, or at least 1 sample aliquot every 3 seconds, or at least 1 sample aliquot every 2 seconds, or 1 sample aliquot every 0.5 seconds, or at least 1 sample aliquot every 0.1 seconds). This shuttle valve is further described in copending U.S. provisional patent application Ser. No. ______, the entire subject matter of which is incorporated herein by reference.

In another exemplary embodiment, universal carrier fluid, including volatile liquids and various gases, may be utilized in the chromatography system to carry a sample to a detector. As shown in FIG. 3A, the carrier fluid from fluid supply 152 enters the shuttle valve 151 at inlet 115 where it picks up sample aliquot 118 (shown in FIG. 10A) and then proceeds via outlet 113 to detector 131. The sample aliquot should not precipitate in the carrier fluid of the valve or the associated plumbing may become blocked, or the sample will coat the walls of the flow path and some or all of the sample will not reach the detector. Sample composition in flash chromatography is very diverse, covering a large spectrum of chemical compounds including inorganic molecules, organic molecules, polymers, peptides, proteins, and oligonucleotides. Solubility in various solvents differs both within and between classes of compounds. Detector compatibility also constrains the types of carrier fluids that may be used. For example, for UV detection, the solvent should be non-chromaphoric at the detection wavelength. For evaporative particle detection (EPD) techniques (ELSD, CNLSD, Mass spec, etc.), the solvent should be easily evaporated at a temperature well below the sample's melting point. In addition, the carrier fluid should be miscible with the sample flowing between the valve inlet 111 and the fraction collector outlet 114. For example, if hexane is used in one flow path, water may not be used in the other flow path because the two are not miscible. All the above suggests the carrier fluid should be customized each time the separation solvents change. This is time consuming and impractical. According to an exemplary embodiment of the present invention, using solvents that are miscible with organic solvents and water, volatile, and non-chromaphoric, averts this problem. For example, a volatile, non-chromaphoric medium polarity solvent, such as isopropyl alcohol (IPA), may be used as the carrier fluid. IPA is miscible with almost all solvents, is non-chromaphoric at common UV detection wavelengths, and is easily evaporated at low temperatures. In addition, IPA dissolves a broad range of chemicals and chemical classes. IPA is thus a suitable carrier fluid for virtually all sample types. Other carrier fluids may include acetone, methanol, ethanol, propanol, butanol, isobutanol, tetrahydrofuran, and the like. In an alternative exemplary embodiment, a gas may be utilized as the carrier fluid. Sample precipitation is not encountered because the sample remains in the separation solvent, or mobile phase, through the shuttle valve and subsequently through the detector. Likewise, the separation solvent, or mobile phase, never mixes with another solvent so miscibility is not an issue. Because the carrier is a gas, volatility is no longer an issue. In addition, most gasses are non-chromaphoric and compatible with UV detection. When using gas as the carrier, the sample aliquot 118 is issued from the valve 151 to the detector 131 as discrete slugs sandwiched between gas pockets 123 as shown in FIG. 10C. Using gas as the carrier fluid has other advantages. For example, when used with an evaporative light scattering detector or other detection technique where the sample is nebulized, the gas may be used to transport the sample and nebulize the sample, eliminating the need for a separate nebulizer gas supply. In addition, because gas does not require evaporation, ambient drift tube temperatures may be used eliminating the need for drift tube heaters. A broader range of samples may be detected because those that would evaporate at higher temperatures will now stay in the solid or liquid state as they pass through the drift tube. A variety of gasses may be used as the carrier gas including air, nitrogen, helium, hydrogen and carbon dioxide. Supercritical fluids may also be used, such as supercritical carbon dioxide.

B. Detection of a Sample Component within a Fluid Stream

The methods of the present invention may further comprise using at least one detector to detect one or more sample components within a fluid stream. Suitable detectors for use in the liquid chromatography systems of the present invention include, but are not limited to, non-destructive and/or destructive detectors. Suitable detectors include, but are not limited to, non-destructive detectors (i.e., detectors that do not consume or destroy the sample during detection) such as UV, RI, conductivity, fluorescence, light scattering, viscometry, polorimetry, and the like; and/or destructive detectors (i.e., detectors that consume or destroy the sample during detection) such as evaporative particle detectors (EPD), e.g., evaporative light scattering detectors (ELSD), condensation nucleation light scattering detectors (CNLSD), etc., corona discharge, mass spectrometry, atomic adsorption, and the like. For example, the apparatus of the present invention may include at least one UV detector, at least one evaporative light scattering detector (ELSD), at least one mass spectrometer (MS), at least one condensation nucleation light scattering detector (CNLSD), at least one corona discharge detector, at least one refractive index detector (RID), at least one fluorescence detector (FD), at least one chiral detector (CD), at least one electrochemical detector (ED) (e.g., amperometric or coulometric detectors), or any combination thereof. In one exemplary embodiment, the detector may comprise one or more evaporative particle detector(s) (EPD), which allows the use of chromaphoric and non-chromaphoric solvents as the mobile phase. In a further exemplary embodiment, a non-destructive detector may be combined with a destructive detector, which enables detection of various compound specific properties of the sample, such as, for example, the chemical entity, chemical structure, molecular weight, etc., associated with each chromatographic peak. When combined with mass spectrometer detection, the fraction's chemical structure and/or molecular weight may be determined at the time of detection, streamlining identification of the desired fraction. In current systems the fraction's chemical identity and structure must be determined by cumbersome past-separation techniques.

Regardless of the type of detector used, a given detector provides one or more detector responses that may be used to generate and send a signal to one or more components (e.g., a fraction collector, another detector, a splitter pump, a shuttle valve, or a tee) within a liquid chromatography system as described herein. Typically, a change in a given detector response triggers the generation and sending of a signal. In the present invention, a change in a given detector response that might trigger the generation and sending of a signal to one or more components includes, but is not limited to, a change in a detector response value, reaching or exceeding a threshold detector response value, a slope of the detector response value over time, a threshold slope of the detector response value over time, a change in a slope of the detector response value over time, a threshold change in a slope of the detector response value over time, or any combination thereof.

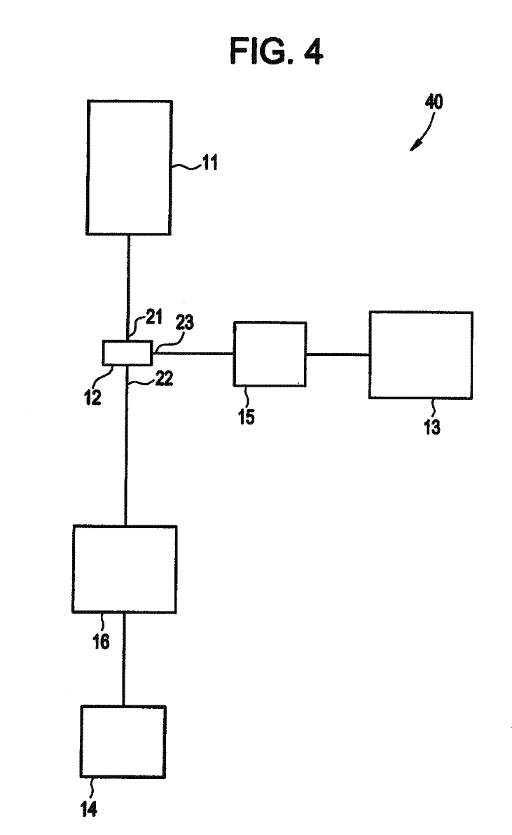

In some exemplary embodiments, the liquid chromatography system of the present invention comprises at least two detectors as shown in FIG. 4. Exemplary liquid chromatography system 40 shown in FIG. 4 comprises chromatography column 11; tee 12 having first inlet 21, first outlet 22 and second outlet 23; fraction collector 14 in fluid communication with first outlet 22 of tee 12; first detector 13 in fluid communication with second outlet 23 of tee 12; splitter pump 15 actively controlling fluid flow to first detector 13 from second outlet 23 of tee 12; and second detector 16 in fluid communication with second outlet 23 of tee 12.

When two or more detectors are present, the liquid chromatography system provides more analysis options to an operator. For example, in exemplary liquid chromatography system 40 shown in FIG. 4, a method of analyzing a sample may comprise a step of sending one or more signals from first detector 13 (e.g., an ELSD) and/or second detector 16 (e.g., an optical absorbance detector such as an UV detector) to fraction collector 14 instructing fraction collector 14 to collect a new sample fraction. The one or more signals from first detector 13 and/or second detector 16 may comprise a single signal from first detector 13 or second detector 16, two or more signals from first detector 13 and second detector 16, or a composite signal from first detector 13 and second detector 16. In exemplary liquid chromatography system 40 shown in FIG. 4, the method of analyzing a sample may further comprise a step of sending a signal from second detector 16 to splitter pump 15 instructing splitter pump 15 to initiate or stop fluid flow to first detector 13 in response to second detector 16 detecting a sample component in a fluid stream.

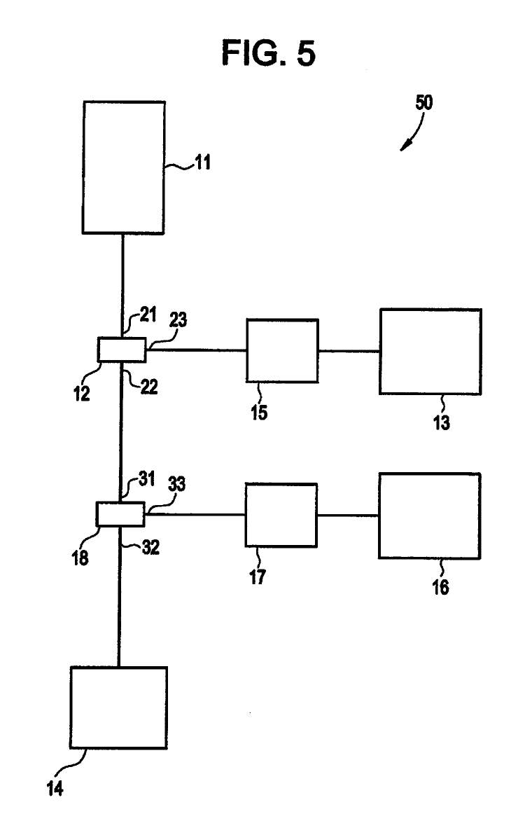

In other exemplary embodiments, the liquid chromatography system of the present invention comprises at least two detectors and at least two splitter pumps as shown in FIG. 5. Exemplary liquid chromatography system 50 shown in FIG. 5 comprises chromatography column 11; first tee 12 having first inlet 21, first outlet 22 and second outlet 23; first detector 13 in fluid communication with second outlet 23 of first tee 12; first splitter pump 15 actively controlling fluid flow to first detector 13 from second outlet 23 of first tee 12; second tee 18 having first inlet 31, first outlet 32 and second outlet 33; second detector 16 in fluid communication with second outlet 33 of second tee 18; second splitter pump 17 actively controlling fluid flow to second detector 16 from second outlet 33 of second tee 18; and fraction collector 14 in fluid communication with second outlet 32 of second tee 18.

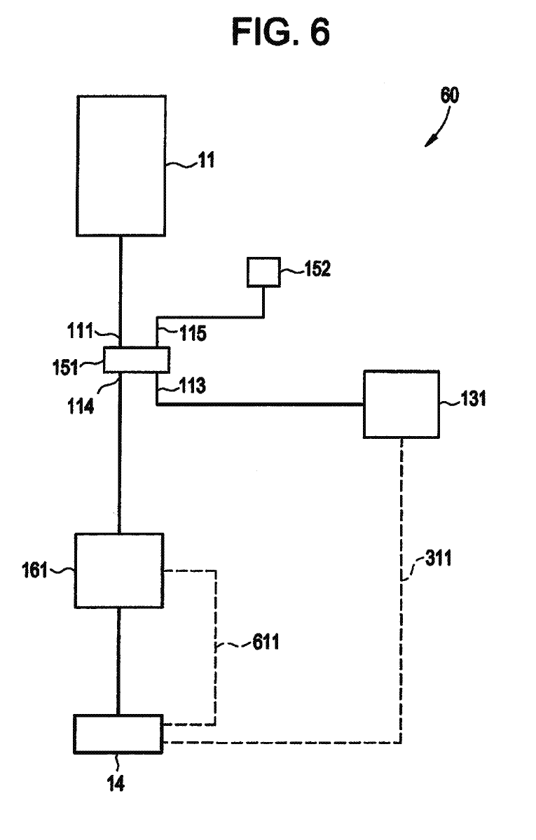

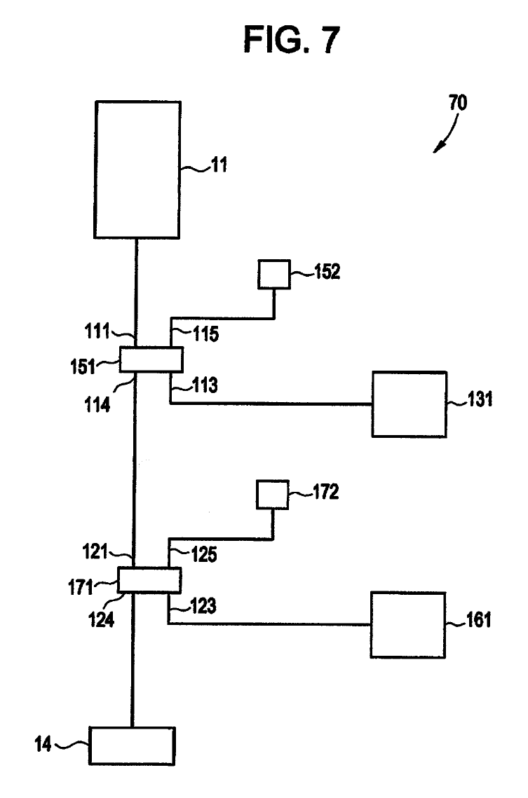

As discussed above, the liquid chromatography systems of the present invention may comprise one or more shuttle valves in place or one or more tee/splitter pump combinations to actively control fluid flow to at least one detector as exemplified in FIGS. 6-7. As shown in FIG. 6, exemplary liquid chromatography system 60 comprises chromatography column 11; shuttle valve 151 having chromatography cartridge inlet 111, fraction collector outlet 114, gas or liquid inlet 115 and detector outlet 113; fraction collector 14 in fluid communication with fraction collector outlet 114 of shuttle valve 151; first detector 131 in fluid communication with detector outlet 113 of shuttle valve 151; fluid supply 152 providing fluid to gas or liquid inlet 115 of shuttle valve 151; and second detector 161 in fluid communication with detector outlet 113 of shuttle valve 151.

As shown in FIG. 7, exemplary liquid chromatography system 70 comprises chromatography column 11; first shuttle valve 151 having chromatography cartridge inlet 111, fraction collector outlet 114, gas or liquid inlet 115 and detector outlet 113; first detector 131 in fluid communication with detector outlet 113 of shuttle valve 151; fluid supply 152 providing fluid to gas or liquid inlet 115 of shuttle valve 151; second shuttle valve 171 having chromatography cartridge inlet 121, fraction collector outlet 124, gas or liquid inlet 125 and detector outlet 123; second detector 161 in fluid communication with detector outlet 123 of shuttle valve 171; fluid supply 172 providing fluid to gas or liquid inlet 125 of shuttle valve 171; and fraction collector 14 in fluid communication with fraction collector outlet 124 of shuttle valve 171.

In these exemplary embodiments, namely, exemplary liquid chromatography systems 50 and 70, a method of analyzing a sample may further comprise a step of actively controlling fluid flow to second detector 16 (or second detector 161) via second splitter pump 17 (or second shuttle valve 171), as well as actively controlling fluid flow to first detector 13 (or first detector 131) via first splitter pump 15 (or first shuttle valve 151). Although not shown in FIG. 5, it should be understood that first splitter pump 15 and/or second splitter pump 17 may be positioned within exemplary liquid chromatography system 50 so as to push or pull fluid through first detector 13 and second detector 16 respectively.

In some exemplary embodiments, one or more optical absorbance detectors, such as one or more UV detectors, may be used to observe detector responses and changes in detector responses at one or more wavelengths across the absorbance spectrum. In these exemplary embodiments, one or more light sources may be used in combination with multiple sensors within a single detector or multiple detectors to detect light absorbance by a sample at multiple wavelengths. For example, one or more UV detectors may be used to observe detector responses and changes in detector responses at one or more wavelengths across the entire UV absorbance spectrum.

In one exemplary method of analyzing a sample, the method comprises the step of using an optical absorbance detector, such as an UV detector, comprising n sensors to observe a sample at n specific wavelengths across the entire UV absorbance spectrum; and collecting a new sample fraction in response to (i) a change in any one of the n detector responses at the n specific UV wavelengths, or (ii) a change in a composite response represented by the n detector responses. The n sensors and multiple detectors, when present, may be positioned relative to one another as desired to affect signal timing to a fraction collector and/or another system component (e.g., another UV detector).

When utilizing whole-spectrum UV (or other spectrum range) analysis, the spectrum may be divided into any desired number of ranges of interest (e.g., every 5 nm range from 200 nm to 400 nm). Any significant change over time in each spectrum range may be monitored. A sudden drop in received light energy (e.g., a drop in both the first and second derivative of the detector response) within a given range may indicate the arrival of a substance that absorbs light in the given wavelength range of interest. In this exemplary embodiment, the width of each range can be made smaller to increase precision; alternatively, the width of each range can be made larger so as to reduce the burden of calculation (i.e., fewer calculations per second, less memory required).

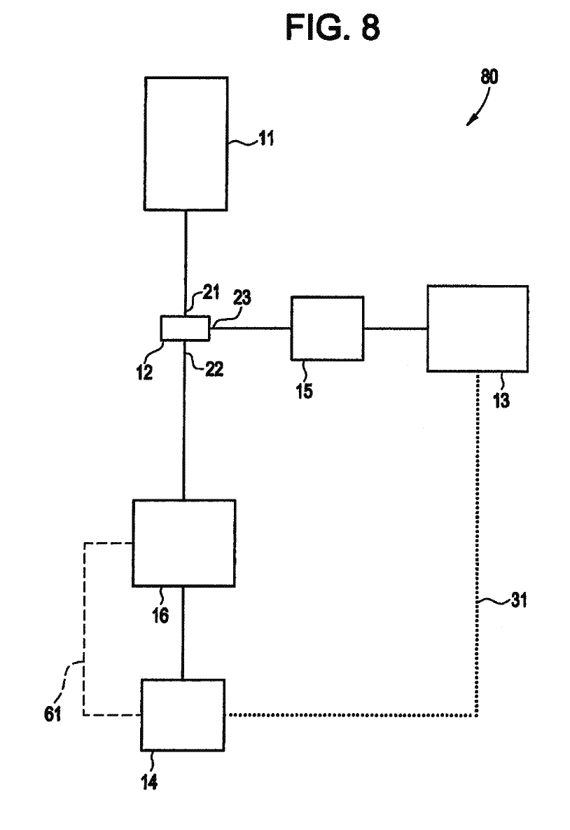

In other exemplary embodiments, a plurality of different types of detectors may be used to observe a variety of detector responses and changes in the detector responses within a given system. In exemplary liquid chromatography system 80 shown in FIG. 8, an evaporative particle detector (EPD), such as an evaporative light scattering detector (ELSD) (i.e., first detector 13) is used alone or in combination with an UV detector (i.e., second detector 16). Exemplary liquid chromatography system 80 further comprises chromatography column 11; tee 12 having first inlet 21, first outlet 22 and second outlet 23; fraction collector 14; EPD 13 in fluid communication with second outlet 23 of tee 12; splitter pump 15 actively controlling fluid flow to EPD 13; and UV detector 16 in fluid communication with first outlet 22 of tee 12. In this exemplary embodiment, the use of evaporative particle detection offers several advantages. Non-chromaphoric mobile phases must be used with UV detection or the mobile phase's background absorbance would obliterate the sample signal. This precludes using solvents such as toluene, pyridine and others that have otherwise valuable chromatographic properties. With evaporative particle detection, the mobile phase chromaphoric properties are immaterial. As long as the mobile phase is more volatile than the sample, it may be used with evaporative particle detection. This opens the opportunity to improve separations through the use of highly selective chromaphoric solvents as the mobile phase. Moreover, UV detectors will not detect non-chromaphoric sample components. Fractions collected based on UV detection only may contain one or more unidentifiable non-chromaphoric components, which compromises fraction purity. Conversely, non-chromaphoric samples may be completely missed by UV detection and either sent directly to waste or collected in fractions assumed to be sample-free (blank fractions). The net result is lost productivity, contaminated fractions, or loss of valuable sample components. When an EPD (e.g., ELSD) is utilized alone or with UV detection in the flash system, chromaphoric and non-chromaphoric components are detected and collected, improving fraction purity. Because a flash system that includes UV detector alone may miss sample components or incorrectly flag pure fractions, many flash users will screen collected fractions by thin layer chromatography to confirm purity and confirm blank fractions are truly blank. This is a time-consuming post-separation procedure that slows down workflow. Those fractions discovered to contain more than one component will frequently require a second chromatography step to properly segregate the components.

In exemplary liquid chromatography system 80, signals 31 and 61 from detector (e.g., ELSD) 13 and UV detector 16 respectively may be sent to fraction collector 14 to initiate some activity from fraction collector 14 such as, for example, collection of a new sample fraction. In desired exemplary embodiments, in response to one or more detector signals 31 and 61 from (i) detector ELSD 13, (ii) UV detector 16, or (iii) both ELSD 13 and UV detector 16, fraction collector 14 collects a new sample fraction.

Similar to exemplary liquid chromatography system 80, in exemplary liquid chromatography system 60 shown in FIG. 6, signals 311 and 611 from ELSD 131 and UV detector 161 respectively may be sent to fraction collector 14 to initiate some activity from fraction collector 14 such as, for example, collection of a new sample fraction. In desired exemplary embodiments, in response to one or more detector signals 311 and 611 from (i) ELSD 131, (ii) UV detector 161, or (iii) both ELSD 131 and UV detector 161, fraction collector 14 collects a new sample fraction.

As discussed above, UV detector 16 (or UV detector 161) may comprise n sensors operatively adapted to observe a sample at n specific wavelengths across a portion of or the entire UV absorbance spectrum. In exemplary liquid chromatography system 80 shown in FIG. 8, in response to (i) a single signal from either one of ELSD 13 or UV detector 16, (ii) two or more signals from both ELSD 13 and UV detector 16, or (iii) a composite signal comprising two or more detector responses (i.e., up to n detector responses) at the two or more specific UV wavelengths (i.e., up to n specific UV wavelengths), fraction collector 14 collects a new sample fraction. Similarly, in exemplary liquid chromatography system 60 shown in FIG. 6, in response to (i) a single signal from either one of ELSD 131 or UV detector 161, (ii) two or more signals from both ELSD 131 and UV detector 161, or (iii) a composite signal comprising two or more detector responses (i.e., up to n detector responses) at the two or more specific UV wavelengths (i.e., up to n specific UV wavelengths), fraction collector 14 collects a new sample fraction.

Further, in exemplary liquid chromatography system 80, UV detector 16 may be used to produce a detector signal (not shown) that (1) results (i) from a single detector response from a single sensor or (ii) from n detector responses of n sensors with n being greater than 1, and (2) is sent to at least one of splitter pump 15, ELSD 13 and tee 12. In addition, a detector signal (not shown) resulting from a detector response in ELSD 13 may be sent to UV detector 16 to change one or more settings of UV detector 16. Similarly, in exemplary liquid chromatography system 60 shown in FIG. 6, UV detector 161 may be used to produce a detector signal (not shown) that (1) results (i) from a single detector response from a single sensor or (ii) from n detector responses of n sensors with n being greater than 1, and (2) is sent to at least one of shuttle valve 151 and ELSD 13. In addition, a detector signal (not shown) resulting from a detector response in ELSD 131 may be sent to UV detector 161 to change one or more settings of UV detector 161.

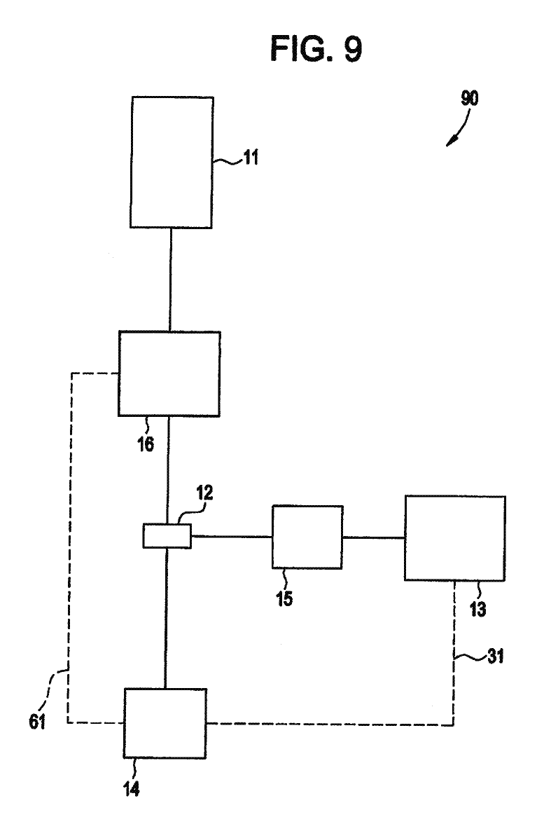

As shown in exemplary liquid chromatography system 90 shown in FIG. 9, the position of different types of detectors within a given system may be adjusted as desired to provide one or more system process features. In exemplary liquid chromatography system 90, ELSD 13 is positioned downstream from UV detector 16. In such a configuration, UV detector 16 is positioned to be able to provide a detector response and generate signal 61 (e.g., a signal that results (i) from a single detector response from a single sensor or (ii) from n detector responses of n sensors with n being greater than 1) for fraction collector 14 prior to the generation of signal 31 from ELSD 13. UV detector 16 is also positioned to be able to provide a detector response and generate a signal (not shown) (e.g., a signal that results (i) from a single detector response from a single sensor or (ii) from n detector responses of n sensors with n being greater than 1) for at least one of splitter pump 15, ELSD 13 and tee 12 so as to activate or deactivate splitter pump 15, ELSD 13 and/or tee 12.

Although not shown, it should be understood that a shuttle valve may be used in place of tee 12 and splitter pump 15 within exemplary liquid chromatography system 90 shown in FIG. 9 to provide similar system process features. In such a configuration, UV detector 16 is positioned to be able to provide a detector response and generate signal 61 (e.g., a signal that results (i) from a single detector response from a single sensor or (ii) from n detector responses of n sensors with n being greater than 1) for fraction collector 14 prior to the generation of signal 31 from ELSD 13. UV detector 16 is also positioned to be able to provide a detector response and generate a signal (not shown) (e.g., a signal that results (i) from a single detector response from a single sensor or (ii) from n detector responses of n sensors with n being greater than 1) for at least one of a shuttle valve and ELSD 13 so as to activate or deactivate the shuttle valve and/or ELSD 13. Even though systems 60, 80, and 90 refer to ELSD and UV as the detectors, any destructive detector, such as EPD, may be utilized for the ELSD, and any non-destructive detector may be utilized in place of the UV detector.

In other exemplary embodiments, the liquid chromatography system of the present invention may comprise a non-destructive system comprising two or more non-destructive detectors (e.g., one or more optical absorbance detectors, such as the UV detectors described above) with no destructive detectors (e.g., a mass spectrometer) present in the system. In one exemplary embodiment, the liquid chromatography system comprises two optical absorbance detectors such as UV detectors, and the method of analyzing a sample comprises the step of using two or more detectors to observe a sample at two or more specific wavelengths; and collecting a new sample fraction in response to (i) a change in a first detector response at a first wavelength, (ii) a change in a second detector response at a second wavelength, or (iii) a change in a composite response represented by the first detector response and the second detector response. In these exemplary embodiments, the first wavelength may be substantially equal to or different from the second wavelength.

In exemplary embodiments utilizing two or more optical absorbance detectors, such as two or more UV detectors, the optical absorbance detectors may be positioned within a given liquid chromatography system so as to provide one or more system advantages. The two or more optical absorbance detectors may be positioned in a parallel relationship with one another so that a sample reaches each detector at substantially the same time, and the two or more optical absorbance detectors may produce and send signals (i.e., from first detector and second detector responses) at substantially the same time to a fraction collector.

In a further exemplary embodiment, a non-destructive detector (e.g., RI detector, UV detector, etc.) may be used alone or in combined with a destructive detector (e.g., EPD, mass spectrometer, spectrophotometer, emission spectroscopy, NMR, etc.). For example, a destructive detector, such as a mass spectrometer detector, enables simultaneous detection of the component peak and chemical entity associated with the peak. This allows for immediate determination of the fraction that contains the target compound. With the other detection techniques, post separation determination of which fraction contains the target compound may be required, such as by, for example, spectrophotometry, mass spectrometry, emission spectroscopy, NMR, etc. If two or more chemical entities elute at the same time from the flash cartridge (i.e., have the same retention time), they will be deposited in the same vial by the system when using certain detectors (i.e., those detectors that cannot identify differences between the chemical entities) because these detectors cannot determine chemical composition. In an exemplary embodiment where a mass spectrometer detector is utilized as the destructive detector, all compounds that elute at the same time may be identified. This eliminates the need to confirm purity after separation.

In any of the above-described liquid chromatography systems, it may be advantageous to position at least one detector, such as at least one UV detector, downstream from (e.g., in series with) at least one other detector, such as at least one other UV detector or an ELSD. In such an exemplary embodiment, a first detector response in a first detector can be used to produce and send a signal to at least one of (1) a splitter pump, (2) a shuttle valve, (3) a second detector and (4) a tee. For example, a first detector response in a first detector can be used to produce and send a signal to a splitter pump or a shuttle valve to (i) activate the splitter pump or the shuttle valve, (ii) deactivate the splitter pump or the shuttle valve, (iii) change one or more flow or pressure settings of the splitter pump or the shuttle valve, or (iv) any combination of (i) to (iii). Suitable flow and pressure settings include, but are not limited to, the flow and pressure settings described above. Typically, the signal is in the form of, for example, an electrical signal, a pneumatic signal, a digital signal, or a wireless signal.

In some exemplary embodiments, multiple detectors (i.e., two or more detectors) may be positioned so that each detector can send a signal to at least one of (1) a splitter pump, (2) a shuttle valve, (3) another detector and (4) a tee independently of the other detectors in the system. For example, multiple optical absorbance detectors (e.g., UV detectors) may be positioned within a given system to provide independent signals to a shuttle valve to cause the shuttle valve to provide actively controlled fluid sampling to another detector such as an ELSD.

In other exemplary embodiments, a first detector response in a first detector can be used to produce and send a signal to a second detector to (i) activate the second detector, (ii) activate the second detector at a wavelength substantially similar to a first wavelength used in the first detector, (iii) activate the second detector at a wavelength other than the first wavelength used in the first detector, (iv) deactivate the second detector, (v) change some other setting of the second detector (e.g., the observed wavelength of the second detector), or (vi) any combination of (i) to (v).

In yet other exemplary embodiments, a first detector response in a first detector can be used to produce and send a signal to a tee to (i) open a valve or (ii) close a valve so as to start or stop fluid flow through a portion of the liquid chromatography system. As discussed above, typically, the signal is in the form of, for example, an electrical signal, a pneumatic signal, a digital signal, or a wireless signal.

C. Generation of a Signal from a Detector Response

The methods of the present invention may further comprise the step of generating a signal from one or more detector responses. In some exemplary embodiments, such as exemplary liquid chromatography system 10 shown in FIG. 1, a single detector detects the presence of a sample component and produces a detector response based on the presence and concentration of a sample component within a fluid stream. In other exemplary embodiments, such as exemplary liquid chromatography system 50 shown in FIG. 6, two or more detectors may be used to detect the presence of one or more sample components, and produce two or more detector responses based on the presence and concentration of one or more sample components within a fluid stream.

As discussed above, a given detector provides one or more detector responses that may be used to generate and send a signal to one or more components (e.g., a fraction collector, another detector, a splitter pump, a shuttle valve, or a tee) within a liquid chromatography system as described herein. Typically, a change in a given detector response triggers the generation and sending of a signal. Changes in a given detector response that might trigger the generation and sending of a signal to one or more components include, but are not limited to, a change in a detector response value, reaching or exceeding a threshold detector response value, a slope of the detector response value over time, a threshold slope of the detector response value over time, a change in a slope of the detector response value over time, a threshold change in a slope of the detector response value over time, or any combination thereof.

In one exemplary embodiment, the methods of the present invention comprise the step of generating a detector signal from at least one detector, the detector signal being generated in response to (i) the slope of a detector response as a function of time (i.e., the first derivative of a detector response), (ii) a change in the slope of the detector response as a function of time (i.e., the second derivative of the detector response), (iii) optionally, a threshold detector response value, or (iv) any combination of (i) to (iii) with desired combinations comprising at least (i) or at least (ii). In this exemplary embodiment, a substance is recognized from the shape of the detector response, specifically the first and/or second derivative of the detector response over time (i.e., slope and change in slope, respectively). In particular, a computer program analyzes the time sequence of detector response values and measures its rate of change (i.e., the first derivative), and the rate of the rate of change (i.e., the second derivative). When both the first derivative and the second derivative are increasing, a substance is beginning to be detected. Similarly, when both the first derivative and the second derivative are decreasing, the substance is ceasing to be detected.

Real-world detector values are typically noisy (e.g., jagged), so it is desirable to utilize low-pass numerical filtering (e.g., smoothing) over time. Consequently, the step of generating a detector signal from at least one detector desirably further comprises low-pass numerical filtering of (i) slope data over time, (ii) change in slope data over time, (iii) optionally, a threshold detector response value, or (iv) any combination of (i) to (iii) to distinguish actual changes in (i) slope data over time, (ii) change in slope data over time, (iii) optionally, a threshold detector response value, or (iv) any combination of (i) to (iii) from possible noise in the detector response. In desired exemplary embodiments, a finite impulse response (FIR) filter or infinite impulse response (IIR) filter may be utilized for low-pass numerical filtering of data over time (e.g., perhaps just an average of several samples). Typically, the decision algorithm utilizes a small number of sequential successes in time as confirmation of a real detector response/signal, and not noise.

In other exemplary embodiments, the method of analyzing a sample may comprise generating a composite signal comprising a detection response component from each detector, and collecting a new sample fraction in response to a change in the composite signal. In these exemplary embodiments, the step of generating a composite signal may comprise mathematically correlating (i) a detector response value, (ii) the slope of a given detector response as a function of time (i.e., the first derivative of a given detector response), (iii) a change in the slope of the given detector response as a function of time (i.e., the second derivative of the given detector response), or (iv) any combination of (i) to (iii) from each detector (i.e., each of the two or more detectors). For example, in some exemplary embodiments, the composite signal may comprise (i) the product of detector response values for each detector (i.e., each of two or more detectors) at a given time, (ii) the product of the first derivatives of the detector responses at a given time, (iii) the product of the second derivatives of the detector responses at a given time, or (iv) any combination of (i) to (iii).

In other exemplary embodiments in which a composite signal is used, the step of generating a composite signal may comprise mathematically correlating (i) a detector response value, (ii) the slope of a given detector response as a function of time (i.e., the first derivative of a given detector response), (iii) a change in the slope of the given detector response as a function of time (i.e., the second derivative of the given detector response), or (iv) any combination of (i) to (iii) from each sensor within a detector (i.e., n sensors observing a sample at n specific wavelengths) alone or in combination with any other detector responses present in the system. For example, in some exemplary embodiments, the composite signal may comprise (i) the product of detector response values for each sensor within a detector (i.e., n sensors observing a sample at n specific wavelengths) and any additional detector response values from other detectors (e.g., from an ELSD used in combination with an UV detector) at a given time, (ii) the product of the first derivatives of the detector responses for each sensor within a detector (i.e., n sensors observing a sample at n specific wavelengths) and any additional detector responses from other detectors at a given time, (iii) the product of the second derivatives of the detector responses for each sensor within a detector (i.e., n sensors observing a sample at n specific wavelengths) and any additional detector responses from other detectors at a given time, or (iv) any combination of (i) to (iii).

In another exemplary embodiment, a method of analyzing a sample may include generating a signal from one or more detectors in a liquid chromatography system, the signal comprising a detection response component from at least one detector; collecting a new sample fraction in a fraction collector in response to a change in the signal; and modifying amplitude of the signal from the one or more detectors of the liquid chromatography system. Such amplitude modification may be performed by electronic or digital, optical, mechanical, or fluidic means.

In an exemplary embodiment where the amplitude of the signal from the one or more detectors is modified electronically or digitally, such modification may be performed by changing the gain of the signal using a component of the chromatography system. The gain may be changed using computer software or a computer readable medium, which is programmed to adjust the signal level by mathematical manipulations, such as multiplication. The signal may be changed electronically by changing the electronic processing of the signal by analog of digital means, for example, changing the type or settings for an operational amplifier.

In an exemplary embodiment where the amplitude of the signal from the one or more detectors is modified optically, such modification may be performed by a light source in the one or more of the detectors of the chromatography system. In one exemplary embodiment, the amplitude of the signal may be modified by using a different light source in each of the one or more of the detectors of the chromatography system. In another exemplary embodiment, the amplitude of the signal may be modified by changing the intensity of a light source in the one or more of the detectors of the chromatography system. In a further exemplary embodiment, the amplitude of the signal may be modified by using multiple light sources in each of the one or more of the detectors of the chromatography system. For example, in the case of an evaporative light scattering detector, increasing the power of the light source increases the amount of light scattered by the sample particles as they pass through the detector. The increase in scattered light increases the amplitude of the signal.

In an exemplary embodiment where the amplitude of the signal from the one or more detectors is modified by fluidic means, such modification may be performed by changing the amount of sample transferred to the one or more of the detectors of the chromatography system. In another exemplary embodiment, the amplitude of the signal may be modified by changing the amount of sample transferred to the one or more of the detectors of the chromatography system by changing the flow rate of the sample through the fluid transfer device. In a further exemplary embodiment, the amplitude of the signal may be modified by changing the amount of sample transferred to the one or more of the detectors of the chromatography system by changing the flow path of the sample through the fluid transfer device. In another exemplary embodiment, the amplitude of the signal may be modified by changing the amount of sample transferred to the one or more of the detectors of the chromatography system by using multiple fluid transfer devices. In an even further exemplary embodiment, the amplitude of the signal is modified by changing the amount of sample transferred to the one or more of the detectors of the chromatography system by using interchangeable fluid transfer device components. In another exemplary embodiment, the amplitude of the signal may be modified by changing the amount of sample transferred to the one or more of the detectors of the chromatography system comprising changing operating conditions of the fluid transfer device. In a further exemplary embodiment, the amplitude of the signal may be modified by changing the amount of sample transferred to the one or more of the detectors of the chromatography system by changing the shape or size of at least one shuttle valve rotor or stator, the shape or size of at least one stator or rotor chamber (e.g., the sample aliquot volume transfer chamber or dimple) or channel, or combinations thereof. In an even further exemplary embodiment, the amplitude of the signal may be modified by changing the amount of sample transferred to the one or more of the detectors of the chromatography system by changing the shape or size of one or more splitter components, shuttle valve components, or pump components, or combinations thereof. All of these modifications increase the amount of sample reaching the detector, which in turn increases the amplitude of the signal. For example, in an evaporative light scattering detector, increasing the amount of sample increases the number of sample particles reaching the detector optics. This in turn increases the amount of scattered light, increasing the signal amplitude.

In an exemplary embodiment where the amplitude of the signal from the one or more detectors is modified mechanically, such modification may be accomplished by the detector design. In one exemplary embodiment, the modification may be accomplished with the use of multiple detectors having different components for each detector in the chromatography system. In another exemplary embodiment, the amplitude of the signal is modified with the use of interchangeable detectors, or their components, for each detector in the chromatography system. For example, a system might incorporate two evaporative light scattering detectors each with a different power light source. The detector with the higher intensity light source will generate the high amplitude signal relative to the detector with the lower power light source.

In another exemplary embodiment, the amplitude of the signal may be modified by changing the physical characteristics of the sample reaching the detector. For example, in an evaporative light scattering detector, larger particles scatter more light than smaller particles and smaller particles contribute to noise that can mask the sample signal. These particles are produced at the nebulizer and changing, for example, the nebulizer gas flow rate, the nebulizer gas type, the nebulizer liquid flow rate, the nebulizer liquid type, the nebulizer design or type will change the size of particles that produced. For example, cross-flow nebulizers or concentric nebulizers may be used. Larger particles scatter more light, increasing the signal amplitude. In a further exemplary embodiment, a higher amplitude signal is generated by removing the small sample particles from the aerosol stream so that only the larger particles reach the detector. The smaller particles may contribute to background noise that interferes with the signal generated by the larger particles. Removing these smaller particles increases the amplitude of the signal. Impactors of various types and designs known in the art may be used to selectively remove the smaller particles before they reach the detector. Flat plate impactor, screen impactors, spherical impactors, elbow impactors, three dimensional impactors, or other non-linear flow structure impactors, or combinations thereof may be used. In another exemplary embodiment, the size of the particles may be modified by changing the evaporation characteristics. For example, changing the temperature in one or more of the aerosol zones (nebulizer, drift tube, optics block, exhaust block) may bias sample particles to a larger size increasing signal amplitude.

In another exemplary embodiment, the method of analyzing a sample comprises the steps of generating a signal from one or more detectors in a liquid chromatography system, the signal comprising a detection response component from at least one detector; and collecting a new sample fraction in a fraction collector in response to a change in the signal; wherein amplitude of the signal is at least about 2 mV. In this exemplary embodiment, the amplitude of the signal may be at least about 3 mV, 4 mV, 5 mV, 6 mV, 7 mV, 8 mV, 9 mV, 10 mV, or more.

In a further exemplary embodiment, the method of analyzing a sample comprises the steps of generating a signal from one or more detectors in a liquid chromatography system, the signal comprising a detection response component from at least one detector; and collecting a new sample fraction in a fraction collector in response to a change in the signal; wherein the sample fraction is less than or equal to about 100 mg. In this exemplary embodiment, the sample fraction collected may be less than or equal to about 100 mg down to at least about 0.1 mg, or any integer or fraction thereof in this range. For example, the sample fraction collected may be less than or equal to about 90 mg, 80 mg, 70 mg, 60 mg, 50 mg, 40 mg, 30 mg, 20 mg, 10 mg, or less.

In an even further exemplary embodiment, the method of analyzing a sample comprises the steps of generating a signal from one or more detectors in a liquid chromatography system, the signal comprising a detection response component from at least one detector; and collecting a new sample fraction in a fraction collector in response to a change in the signal; wherein the signal is generated by at least about 40 uL/min of sample provided to the one or more detectors. In this exemplary embodiment, the sample provided to the one or more detectors may be at least about 40 uL/min up to about 500 uL/min, or any integer or fraction thereof in this range. For example, the sample provided to the one or more detectors may be at least 50 uL/min, 60 uL/min, 70 uL/min, 80 uL/min, 90 uL/min, 100 uL/min, or greater. The sample may be provided to the one or more detectors in the liquid chromatography system via a fluid transfer device positioned in fluid communication with the at least one detector. The fluid transfer device may include a shuttle valve, a splitter, a pump, or the like.

In another exemplary embodiment, the method of analyzing a sample comprises the steps of generating a signal from one or more detectors in a liquid chromatography system, the signal comprising a detection response component from at least one detector; and collecting a new sample fraction in a fraction collector in response to a change in the signal; wherein the one or more detectors comprises an ELSD and the signal is generated from a light source of greater than about 1 mW. In this exemplary embodiment, the signal may be generated from a light source of at least about 1 mW up to about 100 mW, or any integer or fraction thereof in this range. For example, the signal may be generated from a light source of at least about 1 mW, 2 mW, 3 mW, 4 mW, 5 mW, 6 mW, 7 mW, 8 mW, 9 mW, 10 mW, or more.

In a further exemplary embodiment, the method of analyzing a sample comprises the steps of generating a signal from two or more detectors in a liquid chromatography system, the signal comprising a detection response component from at least one detector; and collecting a new sample fraction in a fraction collector in response to a change in the signal; wherein the two or more detectors comprises multiple detectors having different dynamic ranges. In some samples, there may be some components present in large quantities and some components in small quantities. In this case the detectors must have a large dynamic range. When the dynamic range is exceeded on the high end, the sample signal amplitude is so large that a portion of the peak is not seen, the portion above the dynamic range. If a single sample contains more than one component, where one is within the detector's dynamic range and the other is outside the dynamic range, one of the components may not be collected properly. A particular detector's dynamic range depends on the detection principle and the construction.

For example, if a detector has a 100 to 1 dynamic range and the smallest sample amount that will trigger the fraction collector is 100 mg, then the largest sample amount that will not be obscured at the upper detector range is 1000 mg (100 mg×dynamic range). If a sample contains one component at 200 mg and one at 500 mg, the fraction collector will correctly isolate the components. If one component is at 1 mg and the other is at 200 mg, the first component won't be collected. Or if the first component is at 200 mg and the second is at 1500 mg, the second component may not be collected properly because the upper portion of the peak won't be visible and might actually be multiple components insufficiently resolved to show a valley lower than the upper dynamic range. In these last two cases it's not possible to achieve acceptable results.

According to one exemplary embodiment, one way to overcome this problem is by using more than one detector in the same system. One detector may have a different dynamic range than the other. The two detectors might be the same type with different construction (i.e. two ELSD's with different light sources), or detectors of different types (i.e. UV and ELSD). In these cases the total dynamic range is the smallest collectable amount and the largest detectable amount from both detectors. For example, if the first detector has a smallest collectable amount of 10 mg and 100 to 1 dynamic range, then it will work properly with samples from 10 mg to 1000 mg. If the second detector has a smallest collectable amount of 50 mg and a 100 to 1 dynamic range, then it will work properly with samples from 50 mg to 5000 mg. However, the combination will properly collect between 10 mg and 5000 mg, a dynamic range of 500 to 1. Alternately, the same detector might have two zones with different dynamic ranges. For example, an ELSD might incorporate two light sources with different powers. Or a UV detector might contain flow cells with different light path lengths.

D. Collection of One or More Sample Fractions

The methods of the present invention may further comprise using a fraction collector, such as exemplary fraction collector 14 shown in FIGS. 1-3A and 4-9, to collect one or more sample fractions in response to one or more signals from at least one detector in a given liquid chromatography system. For example, in exemplary liquid chromatography systems 10, 20 and 30 shown in FIGS. 1, 2 and 3A respectively, methods of analyzing a sample may further comprise the step of collecting one or more sample fractions in response to one or more signals from first detector 13. In exemplary liquid chromatography systems 40, 50 and 60 shown in FIGS. 4, 5 and 6 respectively, methods of analyzing a sample may further comprise the step of collecting one or more sample fractions in response to one or more signals from first detector 13 (or first detector 131), second detector 16 (or second detector 161), or both first and second detectors 13 and 16 (or both first and second detectors 131 and 161).

In some exemplary embodiments of the present invention, the fraction collector is operatively adapted to recognize, receive and process one or more signals from at least one detector, and collect one or more sample fractions based on the one or more signals. In other exemplary embodiments, additional computer or microprocessing equipment is utilized to process one or more signals from at least one detector and subsequently provide to the fraction collector a recognizable signal that instructs the fraction collector to collect one or more sample fractions based on one or more signals from the additional computer or microprocessing equipment.

As discussed above, system components may be positioned within a given liquid chromatography system to provide one or more system properties. For example, at least one detector may be positioned within a given liquid chromatography system so as to minimize any time delay between (i) the detection of a given detector response and (ii) the step of collecting a sample fraction based on a signal generated from the detector response. In exemplary embodiments of the present invention, the liquid chromatography system desirably exhibits a maximum time delay of a given detector signal to the fraction collector (i.e., the time delay between (i) the detection of a given detector response and (ii) the step of collecting a sample fraction based on a signal generated from the detector response) of less than about 2.0 seconds (s) (or less than about 1.5 s, or less than about 1.0 s, or less than about 0.5 s).

In exemplary embodiments of the present invention utilizing two or more detectors or at least one detector comprising n sensors (as described above), the liquid chromatography system desirably exhibits a maximum time delay for any detector signal from any detector to the fraction collector (i.e., the time delay between (i) the detection of a given detector response and (ii) the step of collecting a sample fraction based on a signal (e.g., single or composite signal) generated from the detector response) of less than about 2.0 s (or less than about 1.5 s, or less than about 1.0 s, or less than about 0.5 s).

E. Sample Component(s) Separation Step

The methods of the present invention utilize a liquid chromatography (LC) step to separate compounds within a given sample. Depending on the particular sample, various LC columns, mobile phases, and other process step conditions (e.g., feed rate, gradient, etc.) may be used.

A number of LC columns may be used in the present invention. In general, any polymer or inorganic based normal phase, reversed phase, ion exchange, affinity, hydrophobic interaction, hydrophilic interaction, mixed mode and size exclusion columns may be used in the present invention. Exemplary commercially available columns include, but are not limited to, columns available from Grace Davison Discovery Sciences under the trade names VYDAC®, GRACERESOLV™, DAVISIL®, ALLTIMA™, VISION™, GRACEPURE™, EVEREST®, and DENALI®, as well as other similar companies.

A number of mobile phase components may be used in the present invention. Suitable mobile phase components include, but are not limited to, acetonitrile, dichloromethane, ethyl acetate, heptane, acetone, ethyl ether, tetrahydrofuran, chloroform, hexane, methanol, isopropyl alcohol, water, ethanol, buffers, and combinations thereof.

F. User Interface Steps

The methods of analyzing a sample in the present invention may further comprise one or more steps in which an operator or user interfaces with one or more system components of a liquid chromatography system. For example, the methods of analyzing a sample may comprise one or more of the following steps: inputting a sample into the liquid chromatography system for testing; adjusting one or more settings (e.g., flow or pressure settings, wavelengths, etc.) of one or more components within the system; programming at least one detector to generate a signal based on a desired mathematical algorithm that takes into account one or more detector responses from one or more sensors and/or detectors; programming one or more system components (other than a detector) to generate a signal based on a desired mathematical algorithm that takes into account one or more detector responses; programming a fraction collector to recognize a signal (e.g., a single or composite signal) from at least one detector, and collect one or more sample fractions based on a received signal; programming one or more system components (other than a fraction collector) to recognize an incoming signal from at least one detector, convert the incoming signal into a signal recognizable and processible by a fraction collector so that the fraction collector is able to collect one or more sample fractions based on input from the one or more system components; and activating or deactivating one or more system components (e.g., a tee valve, a splitter pump, a shuttle valve or a detector) at a desired time or in response to some other activity within the liquid chromatography system (e.g., a detector response displayed to the operator or user).

### II. Apparatus for Analyzing Samples

The present invention is also directed to an apparatus and apparatus components capable of analyzing a sample or capable of contributing to the analysis of a sample using one or more of the above-described method steps.

As described above, in some exemplary embodiments of the present invention, an apparatus for analyzing a sample may comprise (i) a chromatography column; (ii) a tee having a first inlet, a first outlet and a second outlet; (iii) a fraction collector in fluid communication with the first outlet of the tee; (iv) a first detector in fluid communication with the second outlet of the tee; and (v) a splitter pump positioned in fluid communication with the second outlet of the tee and the first detector with the splitter pump being operatively adapted to actively control fluid flow to the first detector. In other exemplary embodiments of the present invention, a shuttle valve may be used in place of a tee/splitter pump combination to actively control fluid flow to the first detector.

Although not shown in FIGS. 1-9, any of the above-described apparatus (e.g., exemplary liquid chromatography systems 10 to 90) or apparatus components may further comprise system hardware that enables (i) the recognition of a detector response value or a change in a detector response value, (ii) the generation of a single from the detector response value or a change in a detector response value, (iii) the sending of a signal to one or more system components, (iv) the recognition of a generated signal by a receiving component, (v) processing of the recognized signal within the receiving component, and (vi) the initiation of a process step of the receiving component in response to the recognized signal.

In one exemplary embodiment, the apparatus (e.g., exemplary liquid chromatography systems 10 to 90) or a given apparatus component may further comprise system hardware that enables a first detector to send an activation signal to a splitter pump or a shuttle valve to (i) activate the splitter pump or shuttle valve, (ii) deactivate the splitter pump or shuttle valve, (iii) change one or more flow or pressure settings of the splitter pump or shuttle valve, or (iv) any combination of (i) to (iii). Suitable flow and pressure settings may include, but are not limited to, (i) a valve position, (ii) splitter pump or shuttle valve pressure, (iii) air pressure to a valve, or (iv) any combination of (i) to (iii).

In some exemplary embodiments, a splitter pump may be positioned between a tee and a first detector (see, for example, splitter pump 15 positioned between tee 12 and first detector 13 in FIG. 1). In other exemplary embodiments, a first detector may be positioned between a tee and the splitter pump (see, for example, first detector 13 positioned between tee 12 and splitter pump 15 in FIG. 2).

In other exemplary embodiments, the apparatus of the present invention comprise (i) a chromatography column; (ii) two or more detectors; and (iii) a fraction collector in fluid communication with the two or more detectors with the fraction collector being operatively adapted to collect one or more sample fractions in response to one or more detector signals from the two or more detectors. In some exemplary embodiments, the two or more detectors comprise two or more non-destructive detectors (e.g., two or more UV detectors) with no destructive detectors (e.g., mass spectrometer) in the system.

When two or more detectors are present, a splitter pump or shuttle valve may be used to split a volume of fluid flow between a first detector and a second detector. In other exemplary embodiments, a splitter pump or shuttle valve may be used to initiate or stop fluid flow to one detector in response to a detector response from another detector. In addition, multiple splitter pumps and/or shuttle valves may be used in a given system to actively control fluid flow to two or more detectors.

As discussed above, the apparatus may further comprise system hardware that enables generation of a detector signal from one or more detector responses. In one exemplary embodiment, the apparatus comprises system hardware that enables generation of a detector signal that is generated in response to (i) the slope of a detector response as a function of time (i.e., the first derivative of a detector response), (ii) a change in the slope of the detector response as a function of time (i.e., the second derivative of the detector response), (iii) optionally, a threshold detector response value, or (iv) any combination of (i) to (iii) with desired combinations comprising at least (i) or at least (ii). The system hardware desirably further comprises low-pass numerical filtering capabilities for filtering (i) slope data, (ii) change in slope data, (iii) optionally, a threshold detector response value, or (iv) any combination of (i) to (iii) over time to distinguish actual changes in (i) slope data, (ii) change in slope data, (iii) optionally, a threshold detector response value, or (iv) any combination of (i) to (iii) from possible noise in a given detector response.

In multi-detector systems, system hardware may also be used to enable the generation of a composite signal comprising a detection response component from each detector, as well as detection response components from multiple sensors within a given detector. In these exemplary embodiments, the system hardware is operatively adapted to send a command/signal to a fraction collector instructing the fraction collector to collect a new sample fraction in response to a change in the composite signal. The composite signal may comprise a mathematical correlation between (i) a detector response value, (ii) the slope of a given detector response as a function of time (i.e., the first derivative of a given detector response), (iii) a change in the slope of the given detector response as a function of time (i.e., the second derivative of the given detector response), or (iv) any combination of (i) to (iii) from each detector. For example, the composite signal may comprise (i) the product of detector response values for each detector at a given time, (ii) the product of the first derivatives of the detector responses at a given time, (iii) the product of the second derivatives of the detector responses at a given time, or (iv) any combination of (i) to (iii).

In one desired configuration, the apparatus for analyzing a sample comprising at least one detector operatively adapted to observe a sample at two or more specific optical wavelengths (e.g., within the UV spectrum), and system hardware that enables a fraction collector to collect a new sample fraction in response to (i) a change in a detector response at a first wavelength, (ii) a change in a detector response at a second wavelength, or (iii) a change in a composite response represented by detector responses at the first and second wavelengths. Each detector can operate at the same wavelength(s), at different wavelengths, or multiple wavelengths. Further, each detector may be in a parallel relationship with one another, in series with one another, or some combination of parallel and series detectors.

As discussed above, in one exemplary embodiment, the apparatus may comprise a single detector comprising n sensors operatively adapted to observe a sample at n specific optical wavelengths across a portion of or the entire UV absorbance spectrum (or any other portion of the absorbance spectrum using some other type of detector), and system hardware that enables a fraction collector to collect a new sample fraction in response to (i) a change in any one of the n detector responses at the n specific optical wavelengths, or (ii) a change in a composite response represented by the n detector responses.

When a splitter pump or shuttle valve is present to actively control fluid flow to at least one detector, the apparatus for analyzing a sample may further comprise system hardware that enables generation of an activation signal to the splitter pump or shuttle valve to (i) activate the splitter pump or shuttle valve, (ii) deactivate the splitter pump or shuttle valve, (iii) change one or more flow or pressure settings of the splitter pump or shuttle valve, or (iv) any combination of (i) to (iii). The activation signal may be generated, for example, by a system operator or by a system component, such as a detector (i.e., the activation signal being generated and sent by the detector in response to a detector response value or change in a detector response value of the detector as discussed above).

In an even further exemplary embodiment according to the present invention, an apparatus for analyzing a sample of fluid using chromatography includes a first fluid path of effluent from a chromatography column or cartridge; at least one detector that is capable of analyzing the sample of fluid; and a shuttle valve that transfers an aliquot sample of fluid from the first fluid path to the detector(s) without substantially affecting the flow properties of fluid through the first fluid path. The flow of the fluid through the first fluid path may be substantially laminar, due to the first fluid path or channel being substantially linear or straight through at least a portion of the valve. In a further exemplary embodiment, the pressure of the fluid through the first fluid path remains substantially constant and/or it does not substantially increase. In another exemplary embodiment, the flow rate of the fluid may be substantially constant through the first fluid path. In an alternative exemplary embodiment, a second fluid path is utilized to carry the aliquot sample of fluid from the shuttle valve to the detector(s). The flow of fluid through the second fluid path may be substantially laminar due to the second fluid path or channel being substantially linear or straight through at least a portion of the valve. In an exemplary embodiment, the pressure of fluid through the second fluid path is substantially constant and/or it does not substantially increase. In further exemplary embodiment, the flow rate of fluid may be substantially constant through the second fluid path.

In an even further exemplary embodiment, an apparatus for analyzing a sample of fluid using chromatography includes a first fluid path of effluent from a chromatography column; a second fluid path that carries the sample of fluid to at least one detector that is capable of analyzing the sample; and a shuttle valve that transfers an aliquot sample of fluid from the first fluid path to the second fluid path while maintaining a continuous second fluid path through the shuttle valve. In one exemplary embodiment, a continuous first flow path through the shuttle valve is maintained when the aliquot sample of fluid is removed from the first fluid path. In another exemplary embodiment, continuous first and second flow paths through the shuttle valve are maintained when the aliquot sample of fluid is removed from the first fluid path and transferred to the second fluid path.

In exemplary embodiments of the present invention, the apparatus for analyzing a sample further comprises a fraction collector that is operatively adapted to collect one or more sample fractions in response to one or more detector signals from (i) a first detector, (ii) a second detector (or any number of additional detectors), or (iii) both the first and second detectors (or any number of additional detectors). When multiple detectors are utilized, the apparatus may comprise a fraction collector operatively adapted to collect a new sample fraction in response to a change in a composite signal that accounts for one or more detector responses from each detector as described above.

As discussed above, in some exemplary embodiments, the apparatus for analyzing a sample comprises a fraction collector that is operatively adapted to recognize, receive and process one or more signals from at least one detector, and collect one or more sample fractions based on the one or more signals. In other exemplary embodiments, the apparatus for analyzing a sample comprises additional computer or microprocessing equipment that is capable of processing one or more signals from at least one detector and converting an incoming signal into a signal that is recognizable by the fraction collector. In this later exemplary embodiment, the fraction collector collects one or more sample fractions based on the one or more signals from the additional computer or microprocessing equipment, not from signal processing components of the fraction collector.

It should be noted that any of the above-described exemplary liquid chromatography systems may comprise any number of detectors, splitter pumps, tees, and shuttle valves, which may be strategically placed within a given system to provide one or more system properties. For example, although not shown in exemplary liquid chromatography system 60 in FIG. 6, an additional detector could be positioned between column 11 and shuttle valve 151 and/or between shuttle valve 151 and detector 161. Although not shown in exemplary liquid chromatography system 70 in FIG. 7, an additional detector could be positioned between column 11 and shuttle valve 151 and/or between shuttle valve 151 and shuttle valve 171 and/or between shuttle valve 171 and fraction collector 14. Additional detectors may be similarly positioned within exemplary liquid chromatography systems 80 and 90 shown in FIGS. 8 and 9 respectively,

In exemplary embodiments of the present invention, an apparatus for analyzing a sample includes system hardware operatively adapted to generate a signal from one or more detectors in a liquid chromatography system, the signal comprising a detection response component from one or more detectors; and a fraction collector operatively adapted to collect a new sample fraction in response to a change in the signal; wherein the liquid chromatography system is operatively adapted to modify the amplitude of the signal. In some exemplary embodiments, the amplitude of the signal is modified by electronic or digital, optical, mechanical or fluidic means.

In an exemplary embodiment where the amplitude of the signal is modified by electronic or digital means, such modification may be performed by a component of the chromatography system being operatively adapted to change the gain of the signal. The gain may be changed using computer software or a computer readable medium, which is programmed to adjust the signal level by mathematical manipulations, such as multiplication. The signal may be changed electronically by changing the electronic processing of the signal by analog of digital means, for example, changing the type or settings for an operational amplifier.

In an exemplary embodiment where the amplitude of the signal is modified by optical means, such modification may be performed by a light source in the one or more of the detectors of the chromatography system. In one exemplary embodiment, the amplitude of the signal may be modified by the chromatography system being operatively adapted to use a different light source in each of the one or more of the detectors. In another exemplary embodiment, the amplitude of the signal may be modified by the chromatography system being operatively adapted to vary the intensity of a light source in the one or more of the detectors. In a further exemplary embodiment, the amplitude of the signal may be modified by the chromatography system being operatively adapted to use multiple light sources in each of the one or more of the detectors. For example, in the case of an evaporative light scattering detector, increasing the power of the light source increases the amount of light scattered by the sample particles as they pass through the detector. The increase in scattered light increases the amplitude of the signal.

In an exemplary embodiment where the amplitude of the signal is modified by fluidic means, such modification may be performed by the chromatography system being operatively adapted to vary the amount of sample transferred to the one or more of the detectors. In another exemplary embodiment, the amplitude of the signal may be modified by the chromatography system being operatively adapted to vary the amount of sample transferred to the one or more of the detectors by changing the flow rate of the sample through the fluid transfer device. In a further exemplary embodiment, the amplitude of the signal may be modified by the chromatography system being operatively adapted to vary the amount of sample transferred to the one or more of the detectors by changing the flow path of the sample through the fluid transfer device. In another exemplary embodiment, the amplitude of the signal may be modified by the chromatography system being operatively adapted to vary the amount of sample transferred to the one or more of the detectors by using multiple fluid transfer devices. In an even further exemplary embodiment, the amplitude of the signal may be modified by the chromatography system being operatively adapted to vary the amount of sample transferred to the one or more of the detectors by using interchangeable fluid transfer device components. In another exemplary embodiment, the amplitude of the signal may be modified by the chromatography system being operatively adapted to vary the amount of sample transferred to the one or more of the detectors by changing operating conditions of the fluid transfer device. In a further exemplary embodiment, the amplitude of the signal may be modified by the chromatography system being operatively adapted to vary the amount of sample transferred to the one or more of the detectors by changing the shape or size of one or more components of the fluid transfer device. In an exemplary embodiment where a shuttle valve is used as the fluid transfer device, the shape or size of at least one shuttle valve rotor or stator, the shape or size of at least one stator or rotor chamber (e.g. the sample aliquot volume transfer chamber or dimple) or channel, or combinations thereof. In an even further exemplary embodiment, the amplitude of the signal may be modified by the chromatography system being operatively adapted to vary the amount of sample transferred to the one or more of the detectors by changing the shape or size of at least one component of one or more splitter components, shuttle valve components, or pump components, or combinations thereof. All of these modifications increase the amount of sample reaching the detector, which in turn increases the amplitude of the signal. For example, in an evaporative light scattering detector, increasing the amount of sample increases the number of sample particles reaching the detector optics. This in turn increases the amount of scattered light, increasing the signal amplitude.

In an exemplary embodiment where the amplitude of the signal is modified mechanically, such modification may be performed by changing the detector design. In one exemplary embodiment, the amplitude of the signal may be modified by the chromatography system being operatively adapted to use multiple detectors having different components for each of the one or more detectors. In another exemplary embodiment, the amplitude of the signal may be modified by the chromatography system being operatively adapted to use interchangeable detectors, or their components, for each of the one or more detectors. For example, a system might incorporate two evaporative light scattering detectors each with a different power light source. The detector with the higher intensity light source will generate the high amplitude signal relative to the detector with the lower power light source.

In another exemplary embodiment, the amplitude of the signal may be modified by changing the physical characteristics of the sample reaching the detector. For example, in an evaporative light scattering detector, larger particles scatter more light than smaller particles and smaller particles contribute to noise that can mask the sample signal. These particles are produced at the nebulizer and changing, for example, the nebulizer gas flow rate, the nebulizer gas type, the nebulizer liquid flow rate, the nebulizer liquid type, the nebulizer design or type will change the size of particles that produced. For example, cross-flow nebulizers or concentric nebulizers may be used. Larger particles scatter more light, increasing the signal amplitude. In a further exemplary embodiment, a higher amplitude signal is generated by removing the small sample particles from the aerosol stream so that only the larger particles reach the detector. The smaller particles may contribute to background noise that interferes with the signal generated by the larger particles. Removing these smaller particles increases the amplitude of the signal. Impactors of various types and designs known in the art may be used to selectively remove the smaller particles before they reach the detector. Flat plate impactor, screen impactors, spherical impactors, elbow impactors, three dimensional impactors, or other non-linear flow structure impactors, or combinations thereof may be used. In another exemplary embodiment, the size of the particles may be modified by changing the evaporation characteristics. For example, changing the temperature in one or more of the aerosol zones (nebulizer, drift tube, optics block, exhaust block) may bias sample particles to a larger size increasing signal amplitude.

In an exemplary embodiment, the apparatus for analyzing a sample comprises system hardware operatively adapted to generate a signal from one or more detectors in a liquid chromatography system, the signal comprising a detection response component from one or more detectors; and a fraction collector operatively adapted to collect a new sample fraction in response to a change in the signal; wherein the liquid chromatography system is operatively adapted to generate an amplitude of the signal of at least about 2 mV. In this exemplary embodiment, the amplitude of the signal may be at least about 3 mV, 4 mV, 5 mV, 6 mV, 7 mV, 8 mV, 9 mV, 10 mV, or more.

In a further exemplary embodiment, the apparatus for analyzing a sample comprises system hardware operatively adapted to generate a signal from one or more detectors in a liquid chromatography system, the signal comprising a detection response component from one or more detectors; and a fraction collector operatively adapted to collect a new sample fraction in response to a change in the signal; wherein the liquid chromatography system is operatively adapted to collect the sample fraction of less than or equal to about 100 mg. In this exemplary embodiment, the sample fraction collected may be less than or equal to about 100 mg down to at least about 0.1 mg, or any integer or fraction thereof in this range. For example, the sample fraction collected may be less than or equal to about 90 mg, 80 mg, 70 mg, 60 mg, 50 mg, 40 mg, 30 mg, 20 mg, 10 mg, or less. In this exemplary embodiment, the detector(s) may include destructive and non-destructive detectors. For example, the detector(s) may include at least one UV detector, at least one evaporative light scattering detector (ELSD), at least one mass spectrometer (MS), at least one condensation nucleation light scattering detector (CNLSD), at least one corona discharge detector, at least one refractive index detector (RID), at least one fluorescence detector (FD), at least one chiral detector (CD), at least one electrochemical detector (ED), or any combination thereof.

In another exemplary embodiment, the apparatus for analyzing a sample comprises system hardware operatively adapted to generate a signal from one or more detectors in a liquid chromatography system, the signal comprising a detection response component from one or more detectors; and a fraction collector operatively adapted to collect a new sample fraction in response to a change in the signal; wherein the liquid chromatography system is operatively adapted to generate the signal from at least about 30 uL/min. of sample provided to the one or more detectors. In this exemplary embodiment, the sample provided to the one or more detectors may be at least about 40 uL/min up to about 500 uL/min, or any integer or fraction thereof in this range. For example, the sample provided to the one or more detectors may be at least 50 uL/min, 60 uL/min, 70 uL/min, 80 uL/min, 90 uL/min, 100 uL/min, or greater. The sample may be provided to the one or more detectors in the liquid chromatography system via a fluid transfer device positioned in fluid communication with the at least one detector. The fluid transfer device may include a shuttle valve, a splitter, a pump, or the like.

In a further exemplary embodiment, the apparatus for analyzing a sample comprises system hardware operatively adapted to generate a signal from one or more detectors in a liquid chromatography system, the signal comprising a detection response component from one or more detectors; and a fraction collector operatively adapted to collect a new sample fraction in response to a change in the signal; wherein the one or more detectors comprises an ELSD and the signal is generated from a light source of greater than about 1 mW. In this exemplary embodiment, the signal may be generated from a light source of at least about 1 mW up to about 100 mW, or any integer or fraction thereof in this range. For example, the signal may be generated from a light source of at least about 1 mW, 2 mW, 3 mW, 4 mW, 5 mW, 6 mW, 7 mW, 8 mW, 9 mW, 10 mW, or more.

In another exemplary embodiment, the apparatus for analyzing a sample comprises system hardware operatively adapted to generate a signal from two or more detectors in a liquid chromatography system, the signal comprising a detection response component from one or more detectors; and a fraction collector operatively adapted to collect a new sample fraction in response to a change in the signal; wherein the two or more detectors comprises multiple detectors having different dynamic ranges. In this exemplary embodiment, the detectors may include destructive and non-destructive detectors. For example, the at least one detector may be selected from at least one UV detector, at least one evaporative light scattering detector (ELSD), at least one mass spectrometer (MS), at least one condensation nucleation light scattering detector (CNLSD), at least one corona discharge detector, at least one refractive index detector (RID), at least one fluorescence detector (FD), at least one chiral detector (CD), at least one electrochemical detector (ED), or any combination thereof. In another exemplary embodiment, the two or more detectors may include multiple detectors of the same type with different dynamic ranges, such as, for example, multiple ELSDs having different dynamic ranges. In another exemplary embodiment, the two or more detectors may include multiple detectors of the different types with different dynamic ranges, such as, for example, at least one ELSD and one UV detector with different dynamic ranges. In an even further exemplary embodiment, the two or more detectors may include at least one detector having two or more zones with different dynamic ranges, such as, for example, an ELSD with multiple light sources having different power levels, or a UV detector with multiple flow cells having different path lengths, or both.

A number of commercially available components may be used in the apparatus of the present invention as discussed below.

A. Chromatography Columns

Any known chromatography column may be used in the apparatus of the present invention. Suitable commercially available chromatography columns include, but are not limited to, chromatography columns available from Grace Davison Discovery Sciences (Deerfield, Ill.) under the trade designations GRACEPURE™, GRACERESOLV™, VYDAC® and DAVISIL®.

B. Detectors

Any known detector may be used in the apparatus of the present invention. Suitable commercially available detectors include, but are not limited to, UV detectors available from Ocean Optics (Dunedin, Fla.) under the trade designation USB 2000™; evaporative light scattering detectors (ELSDs) available from Grace Davison Discovery Sciences (Deerfield, Ill.) under the trade designation 3300 ELSD™; mass spectrometers (MSs) available from Waters Corporation (Milford, Mass.) under the trade designation ZQ™; condensation nucleation light scattering detectors (CNLSDs) available from Quant (Blaine, Minn.) under the trade designation Q1500™; corona discharge detectors (CDDs) available from ESA (Chelmsford, Mass.) under the trade designation CORONA CAD™; refractive index detectors (RIDs) available from Waters Corporation (Milford Mass.) under the trade designation 2414; and fluorescence detectors (FDs) available from Laballiance (St. Collect, Pa.) under the trade designation ULTRAFLOR™.

In some exemplary embodiments, a commercially available detector may need to be modified or programmed or a specific detector may need to be built in order to perform one or more of the above-described method steps of the present invention.

C. Splitter Pumps

Any known splitter pump may be used in the apparatus of the present invention. Suitable commercially available splitter pumps include, but are not limited to, splitter pumps available from KNF (Trenton, N.J.) under the trade designation LIQUID MICRO™.

D. Shuttle Valves

Any known shuttle valve may be used in the apparatus of the present invention. Suitable commercially available shuttle valves include, but are not limited to, shuttle valves available from Valco (Houston, Tex.) under the trade designation CHEMINERT™, Rheodyne® shuttle valve available from Idex Corporation under the trade name MRA® and a continuous flow shuttle valve as described herein.

E. Fraction Collectors

Any known fraction collector may be used in the apparatus of the present invention. Suitable commercially available fraction collectors include, but are not limited to, fraction collectors available from Gilson (Middleton, Wis.) under the trade designation 215.

In some exemplary embodiments, a commercially available fraction collector may need to be modified and/or programmed or a specific fraction collector may need to be built in order to perform one or more of the above-described method steps of the present invention. For example, fraction collectors that are operatively adapted to recognize, receive and process one or more signals from at least one detector, and collect one or more sample fractions based on the one or more signals are not commercially available at this time.

### III. Computer Software

The present invention is further directed to a computer readable medium having stored thereon computer-executable instructions for performing one or more of the above-described method steps. For example, the computer readable medium may have stored thereon computer-executable instructions for: adjusting one or more settings (e.g., flow settings, wavelengths, etc.) of one or more components within the system; generating a signal based on a desired mathematical algorithm that takes into account one or more detector responses; recognizing a signal from at least one detector; collecting one or more sample fractions based on a received signal; recognizing an incoming signal from at least one detector, convert the incoming signal into a signal recognizable and processible by a fraction collector so that the fraction collector is able to collect one or more sample fractions based on input from the one or more system components; and activating or deactivating one or more system components (e.g., a tee valve, a splitter pump, a shuttle valve, or a detector) at a desired time or in response to some other activity within the liquid chromatography system (e.g., a detector response).

### IV. Applications/Uses

The above-described methods, apparatus and computer software may be used to detect the presence of one or more compounds in a variety of samples. The above-described methods, apparatus and computer software find applicability in any industry that utilizes liquid chromatography including, but not limited to, the petroleum industry, the pharmaceutical industry, analytical labs, etc.

### EXAMPLES

The present invention is further illustrated by the following examples, which are not to be construed in any way as imposing limitations upon the scope thereof. On the contrary, it is to be clearly understood that resort may be had to various other exemplary embodiments, modifications, and equivalents thereof which, after reading the description herein, may suggest themselves to those skilled in the art without departing from the spirit of the present invention and/or the scope of the appended claims.

### Example 1

In this example, two different flash chromatography systems were compared (REVELERIS® systems available from Grace Davison Discovery Sciences). The first (comparative) system (“System A”) was equipped with an ALLTECH® ELSD with a 1 mW laser, a shuttle valve with a 300 mL rotor dimple and a 150 ms dispense and refill time, and an UV detector with 0.1 mm UV flow cell. The second system (“System B”) was equipped with an ALLTECH® ELSD with a 4.6 mW laser (available from Midwest Laser Products, Inc.), a shuttle valve with a 600 mL rotor dimple and a 250 ms dispense and 50 ms refill time, and an Ocean Optics UV detector with 0.1 mm UV flow cell. Both systems are configured as shown in FIG. 3A. 5 mg/mL solutions, each containing five different natural products (i.e., caffeine, emodine, lipoic acid, cathechin, and morin) were prepared by weighing 0.5 g natural product and adding it to a 100 mL volumetric flask and diluted to 100 mL mark with 20/80 methanol/water mixture. For each sample of natural product, 1 mL was injected using a 5 mL plastic syringe into a 4 g GRACERESOLV™ C18 flash column (available from Grace Davison Discovery Sciences), which was mounted in the flash Systems. A mobile phase was pumped through the system under the following gradient conditions; over the first three minutes the amount of methanol is increased up to 60% and subsequently held at 60% for one minute. The column effluent was directed to a shuttle valve that diverted 36 uL/min for System A and 72 uL/min for System B of the column effluent to an ALLTECH® ELSD. The balance of the effluent flowed through a UV detector to a fraction collector.

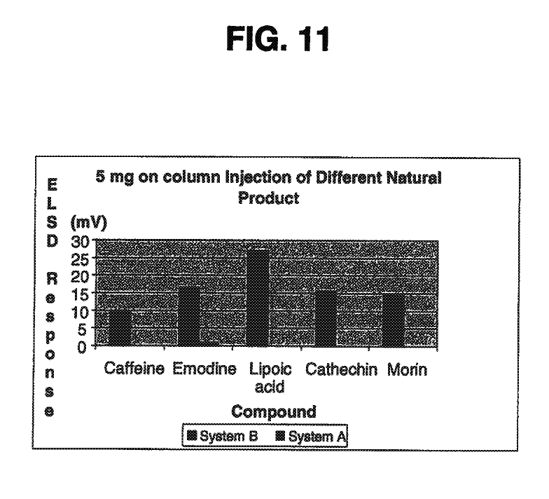

Each sample of natural product was separated on identical 4 g GRACERESOLV™ C18 flash columns. The results shown in FIG. 11 demonstrate that the System A ELSD does not detect any natural product in the sample except for emodine, while the System B ELSD detects all of them.

### Example 2

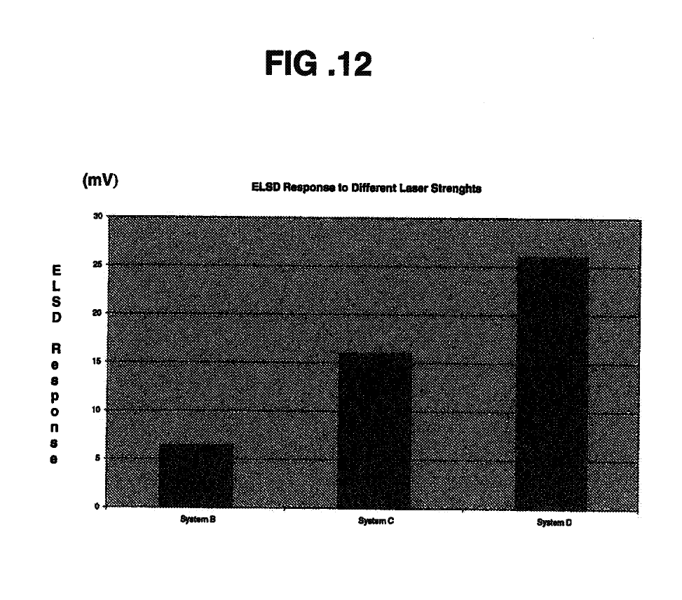

In this example, System B is modified to include a 7.5 mW laser (available from Midwest Laser Products, Inc.) in the ALLTECH® ELSD (“System C”), and also a 10 mW laser (available from Midwest Laser Products, Inc.) in the ALLTECH® ELSD (“System D”). The same separation process is conducted as in Example 1 for only the caffeine sample. The results shown in FIG. 12 demonstrate that the System C ELSD displays a response two to three times that of the System B ELSD, and the System D ELSD displays a response four times that of the System B ELSD.

### Example 3

In this example, the performance of System A is compared with System D. The same separation process is conducted as in Example 1 for only the caffeine sample. The results shown in Table 1 below demonstrate that the System D ELSD displays a response forty times that of the System A ELSD, and the System D UV detector displays a response two times that of the System A UV detector.

TABLE 1

| Response | System A | System D |
|---|---|---|
| ELSD (mV) | 0.65 | 26.0 |
| UV Detector (au) | 0.08 | 0.31 |
| 280 nm | | |

While the invention has been described with a limited number of exemplary embodiments, these specific exemplary embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims. All publications cited herein are incorporated by reference in their entirety.

What is claimed is:

1. A method of analyzing a sample, said method comprising the step of:
(a) generating a signal from one or more detectors in a liquid chromatography system, the signal comprising a detection response component from at least one detector; and
(b) collecting a new sample fraction in a fraction collector in response to a change in the signal;
wherein amplitude of the signal is modified by the liquid chromatography system.

2. The method of claim 1, wherein the amplitude of the signal is modified by electronic or digital means.

3. The method of claim 1, wherein the amplitude of the signal is modified by changing the gain of the signal using a component of the chromatography system.

4. The method of claim 1, wherein the amplitude of the signal is modified by computer software or a computer readable medium.

5. The method of claim 1, wherein the amplitude of the signal is modified by optical means.

6. The method of claim 1, wherein the amplitude of the signal is modified by a light source in the one or more of the detectors of the chromatography system.

7. The method of claim 1, wherein the amplitude of the signal is modified by using a different light source in each of the one or more of the detectors of the chromatography system.

8. The method of claim 1, wherein the amplitude of the signal is modified by changing the intensity of a light source in the one or more of the detectors of the chromatography system.

9. The method of claim 1, wherein the amplitude of the signal is modified by using multiple light sources in each of the one or more of the detectors of the chromatography system.

10. The method of claim 1, wherein the amplitude of the signal is modified by fluidic means.

11. The method of claim 1, wherein the amplitude of the signal is modified by changing the amount of sample transferred to the one or more of the detectors of the chromatography system.

12-60. (canceled)

61. An apparatus for analyzing a sample, said apparatus comprising:
(a) system hardware operatively adapted to generate a signal from one or more detectors in a liquid chromatography system, the signal comprising a detection response component from one or more detectors; and
(b) a fraction collector operatively adapted to collect a new sample fraction in response to a change in the signal;
wherein the liquid chromatography system is operatively adapted to modify amplitude of the signal.

62. The apparatus of claim 61, wherein the amplitude of the signal is modified by electronic or digital means.

63. The apparatus of claim 61, wherein the amplitude of the signal is modified by a component of the chromatography system being operatively adapted to change the gain of the signal.

64. The apparatus of claim 61, wherein the amplitude of the signal is modified by computer software or a computer readable medium.

65. The apparatus of claim 61, wherein the amplitude of the signal is modified by optical means.

66. The apparatus of claim 61, wherein the amplitude of the signal is modified by a light source in the one or more of the detectors of the chromatography system.

67. The apparatus of claim 61, wherein the amplitude of the signal is modified by the chromatography system being operatively adapted to use a different light source in each of the one or more of the detectors.

68. The apparatus of claim 61, wherein the amplitude of the signal is modified by the chromatography system being operatively adapted to vary the intensity of a light source in the one or more of the detectors.

69. The apparatus of claim 61, wherein the amplitude of the signal is modified by the chromatography system being operatively adapted to use multiple light sources in each of the one or more of the detectors.

70. The apparatus of claim 61, wherein the amplitude of the signal is modified by fluidic means.

71. The apparatus of claim 61, wherein the amplitude of the signal is modified by the chromatography system being operatively adapted to vary the amount of sample transferred to the one or more of the detectors.

72-114. (canceled)
